(19) United States
(12) Patent Application Publication
(10) Pub. No.: US 2009/0320077 A1
(43) Pub. Date: Dec. 24, 2009

(54) Method and apparatus for on-demand content transmission and control over networks

(76) Inventor: Robert F. Gazdzinski, San Diego, CA (US)

Correspondence Address: Robert F. Gazdzinski, Esq.;Gazdzinski & Associates, Professional Corporation, 11440 West Bernardo Court, Suite 375, San Diego, CA, 92127, US

(21) Appl. No.: 12/459,045

(22) Filed: Jun. 26, 2009

Related U.S. Application Data
(63) Continuation of application No. 11/258,229, filed on Oct. 24, 2005.

(51) Int. Cl. H04N 7/173; H04N 7/16

(52) U.S. Cl. 725/62; 725/91; 455/414.1

(57) ABSTRACT

Methods and apparatus for delivering content over network infrastructure are disclosed. In one embodiment, the network comprises a content-based (e.g., cable) network coupled to a radio or other service provider network, and a portion of the infrastructure comprises that nominally used for on-demand (OD) services such as VOD. Mobile or other consumer devices (e.g., cellular telephones, PDAs, etc.) capable of accessing the service provider network are able to access the on-demand and related “trick mode” functionality of the content-based network, as well as make use of ancillary functions such as billing modules associated with the content network.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of Invention

The invention relates generally to the fields of video and/or data transmission. In one exemplary aspect, the invention relates to the use of an on-demand (e.g., VOD) infrastructure in content-based (e.g., cable) networks in establishing multimedia sessions with a client mobile device such as a cellular telephone, laptop computer, or personal digital assistant (PDA).

2. Description of Related Technology

The provision of “on-demand” (OD) services, such as e.g., video on-demand or VOD, is well known in the prior art. In a typical configuration, the VOD service makes available to its users a selection of multiple video programs that they can choose from and watch over a network connection with minimum setup delay. At a high level, a VOD system consists of one or more VOD servers that pass and/or store the relevant content; one or more network connections that are used for program selection and program delivery; and customer premises equipment (CPE) to receive, decode and present the video on a display unit. The content is typically distributed to the CPE over a Hybrid Fiber Coaxial (HFC) network, which may include e.g., dense wave division multiplexed (DWDM), coaxial, and other types of bearer media.

Depending on the type of content made available and rate structure for viewing, a particular VOD service could be called “subscription video-on-demand (SVOD)” that gives customers on-demand access to the content for a flat monthly fee, “free video-on-demand (FVOD)” that gives customers free on-demand access to some content, “movies on-demand” where VOD content consists of movies only, and so forth. Many of these services, although referred to by names different than VOD, still share many of the same basic attributes including storage, network and decoder technologies.

Just as different varieties of VOD service offerings have evolved over time, several different network architectures have also evolved for deploying these services. These architectures range from fully centralized (e.g., VOD servers at a central location) to fully distributed (e.g., multiple copies of content distributed on VOD servers very close to customer premises), as well as various other network architectures there between. Since most cable television networks today consist of optical fiber towards the “core” of the network which are connected to coaxial cable networks towards the “edge”, VOD transmission network architectures also consist of a mixture of optical fiber and coaxial cable portions.

The CPE for VOD often consists of a digital cable set-top box (DSTB) that provides the functions of receiving cable signals by tuning to the appropriate RF channel, processing the received signal and outputting VOD signals for viewing on a display unit. Such a digital set-top box also typically hosts a VOD application that enables user interaction for navigation and selection of VOD menu.

While the architectural details of how video is transported in the core HFC network can be different for each VOD deployment, each generally will have a transition point where the video signals are modulated, upconverted to the appropriate RF channel and sent over the coaxial segment(s) of the network. Depending on the topology of the individual cable plant, this could be performed at a node, hub or a headend. The coaxial cable portion of the network is variously referred to as the “access network” or “edge network” or “last mile network.”

In U.S. cable systems for example, downstream RF channels used for transmission of television programs are 6 MHz wide, and occupy a 6 MHz spectral slot between 54 MHz and 860 MHz. Deployments of VOD services have to share this spectrum with already established analog and digital cable television services. For this reason, the exact RF channel used for VOD service may differ from plant to plant. However, within a given cable plant, all homes that are electrically connected to the same cable feed running through a neighborhood will receive the same downstream signal. For the purpose of managing VOD services, these homes are grouped into logical groups typically called Service Groups. Homes belonging to the same Service Group receive their VOD service on the same set of RF channels.

VOD service is typically offered over a given number (e.g., 4) of RF channels from the available spectrum in cable. Thus, a VOD Service Group consists of homes receiving VOD signals over the same 4 RF channels. Reasons for this grouping include (i) that it lends itself to a desirable “symmetry of two” design of products (e.g. Scientific Atlanta's MQAM), and (ii) a simple mapping from incoming Asynchronous Serial Interface (ASI) payload rate of 213 Mbps to four QAM payload rates.

In most cable networks, VOD programs are transmitted using MPEG (e.g., MPEG-2) audio/video compression. Since cable signals are transmitted using Quadrature Amplitude Modulation (QAM) scheme, available payload bitrate for typical modulation rates (QAM-256) used on HFC systems is roughly 38 Mbps. In many VOD deployments, a typical rate of 3.75 Mbps is used to send one video program at resolution and quality equivalent to NTSC broadcast signals. In digital television terminology, this is called Standard Definition (SD) television resolution. Therefore, use of MPEG-2 and QAM modulation enables carriage of 10 SD sessions on one RF channel (10×3.75=37.5 Mbps<38 Mbps). Since a typical Service Group consists of 4 RF channels, 40 simultaneous SD VOD sessions can be accommodated within a Service Group. These numbers work out very well for many deployment scenarios, such as the following example. A typical “service area” neighborhood served by a coaxial cable drop from the cable network consists of 2000 homes, of which about two-thirds are cable subscribers, of which about one-third are digital cable subscribers, of which about 10% peak simultaneous use is expected. Hence, the bandwidth required to meet VOD requirements is 2000×(⅔)×(⅓)×0.1=approximately 40 peak VOD sessions—the exact number supported by a 4 QAM service group. Since high-definition (HD) sessions require a greater bandwidth (typically 15 Mbps), less of these sessions can be accommodated.

Several specific frameworks exist in the prior art for provisioning on-demand (e.g., VOD) and similar services to network subscribers. Notably, in the cable network context, the Interactive Services Architecture (ISA) specification (see, e.g., ISA Versions 1.4 and 1.5) published by the Assignee hereof describes techniques and mechanisms for distributing and delivering movie titles for VOD services. The ISA specification defines functional roles and interfaces that enable the development of pluggable interactive services in a cable environment. The focus of the ISA is primarily on viewer services, which are defined as the set of functions provided by the cable operator to its customers.

Mobile communications systems have evolved to the point of being able to provide multimedia capability to wireless subscribers via the cellular and associated infrastructure. For example, the well known Third Generation (3G) IP multimedia subsystem (IMS) is a core network subsystem within the Universal Mobile Telecommunications System (UMTS). It is based on the Session Initiation Protocol (SIP), which is used to initiate, modify and terminate multimedia sessions such as voice calls and video conferences, as well as streaming media. IMS also uses the IETF Session Description Protocol (SDP) to set the parameters for sessions, and also to negotiate the codecs to be used. SIP can advantageously run atop different IP transport protocols, such as e.g., the well-known User Datagram Protocol (UDP) and Transmission Control Protocol (TCP).

A variety of other approaches for communicating data to and from wireless (mobile) devices, as well as video transmission and session establishment, are present in the prior art. For example, U.S. Pat. No. 5,528,284 to Iwami, et al. issued on Jun. 18, 1996 entitled “Video communication method having refresh function of coding sequence and terminal devices thereof” discloses a video communication system including a sending terminal and a receiving terminal connected via a packet switching network, a receiving terminal which has detected loss of a video packet sets a video output into a freeze status and transmits a refresh request command to the sending terminal. Upon receiving the refresh request command, the sending terminal requests a video coder unit to execute refreshing and transmits a series of video packets beginning from an INTRA frame. Upon receiving a packet of the INTRA frame, the receiving terminal releases the freeze status and restarts video information decoding.

U.S. Pat. No. 6,463,534 to Geiger, et al. issued on Oct. 8, 2002 entitled “Secure wireless electronic-commerce system with wireless network domain” discloses a method of conducting transactions in a wireless electronic commerce system, where the system comprises a wireless network operator certification authority having a root public key certificate and at least one attribute authority having a digital certificate that is dependent from the root public key certificate. The attribute authority is accessible by a wireless client device via a wireless network. The digital certificate is delivered from the attribute authority to the wireless device, the attribute authority is verified to the wireless client device using the digital certificate and the root public key certificate pre-loaded in the wireless client device under authority of the wireless network operator. An attribute (software, service, right/permission or other content item) is delivered to the wireless client device over the wireless network and ultimately enabled at the wireless client device.

U.S. Pat. No. 6,694,145 to Riikonen, et al. issued on Feb. 17, 2004 entitled “Synchronization of signaling messages and multimedia content loading” discloses a method which synchronizes signaling messages and multimedia content loading at a callee terminal. A first signaling message transmitted from a caller terminal to initiate a multimedia session establishment is processed to detect, in the first signaling message, information indicating that the multimedia content should be presented in synchronization with a second signaling message necessary to session establishment. The multimedia content is downloaded and presented in accordance with the information indicating that the multimedia content should be presented in synchronization with said second signaling message necessary to session establishment. The second signaling message necessary to session establishment is delayed until after the step of downloading and presenting the multimedia content in accordance with the information indicating that the multimedia content should be presented in synchronization with the second signaling message is completed.

U.S. Pat. No. 6,788,676 to Partanen, et al. issued on Sep. 7, 2004 entitled “User equipment device enabled for SIP signaling to provide multimedia services with QoS” discloses a user equipment (UE) device including a mobile terminal coupled to a terminal equipment (TE) device including an IP Multimedia Subsystem (IMS) proxy adjunct for use by the TE in making multimedia service requests for IP communications with a desired end-to-end QoS, the end-to-end including the local connection and a network supporting QoS, e.g. an UMTS network having as an extension of its packet-switched core network an IMS providing multimedia services with selected QoS. The IMS proxy adjunct is implemented to make extensions to messages according to any protocol providing a session description protocol (SDP) component, such as SIP or RTSP, so as to ensure the selected QoS. In addition, a mechanism is provided by which the MT informs the IMS when it has IMS proxy capabilities.

U.S. Pat. No. 6,865,374 to Kalluri issued on Mar. 8, 2005 entitled “Video recovery system and method” discloses a recovery system and method for a wireless video communication system. The system comprises: a transmitter for transmitting encoded video data to a wireless device; a receiver for receiving a return signal from the wireless device; a signal analysis system for analyzing the return signal to determine if a degraded signal condition exists between the transmitter and wireless device; and a recovery system that converts a predictive video frame in the encoded video data into an intra-coded video frame if the degraded signal condition exists.

United States Patent Application 20040117480 to Karaoguz, et al. published on Jun. 17, 2004 entitled “Automatic access and control of media peripherals on a media exchange network” discloses methods for automatically monitoring and controlling at least one media peripheral device in a media exchange network. A communication link is established between a media management system (MMS) and a media peripheral (MP) device in the media exchange network and an operation of the MP device is automatically selected via the MMS over the communication link. Finally, the operation of the MP device is automatically carried out (i.e., performed). Also, after establishing a communication link between a media management system (MMS) and a media peripheral (MP) device in the media exchange network, at least one status parameter of the MP device may be automatically monitored via the MMS over the communication link. The status parameter may be automatically stored and/or displayed via the MMS.

United States Patent Application 20040148400 to Mostafa published on Jul. 29, 2004 entitled “Data transmission” discloses a multimedia messaging service (MMS), wherein a user agent is notified of availability of a multimedia message and subsequently, after the user agent has sent a retrieve request, a streamable media component of a multimedia message is streamed to the user agent in a streaming session. The streaming session is established according to Session Description Data (SDD). Responsive to the retrieve request, the multimedia message is delivered to the user agent so that the streamable media component is represented with a descriptor pointing to a location from which the SDD can be obtained. The SDD is generated before or after the user agent requests for retrieval of the multimedia message but not necessarily by the time the user agent is notified for the availability of the multimedia message.

United States Patent Application 20040192272 to Seo published Sep. 30, 2004 entitled “Method of starting an application program of a mobile terminal and method of providing service data in a mobile communication system” discloses a method of starting an application program of a mobile terminal having a data terminating function, the method comprising the steps of: receiving a call establishment request for data termination; establishing a data call according to the call establishment request; determining the type of service specified by an application program starting message, when the application program starting message is received after the call is established; and automatically starting an application program corresponding to the determined type of service. Using this method, it is possible to automatically start an application program capable of processing data terminated to a mobile terminal which has a data terminating function.

While video-on demand (VOD) servers are well known in the prior art to deliver media content to a CPE over a HFC network, VOD servers have to this point not been able to service session requests generated by mobile clients such as cellular telephones, PDAs or even notebook computers. Streaming video content has begun to make headway into the mobile device market by such service providers as SmartVideo Technologies, Inc., a Microsoft Windows Media® 9 series Certified Hosting Provider that provides live television broadcasts directly to a mobile device; however, there has not yet been any way for mobile devices to access VOD or other “on demand” content provided by an MSO (multimedia specific operator) or other content provider. Additionally, no “trick mode” functionality (e.g., pause, play, rewind, fast-forward) has heretofore been available to wireless mobile devices, nor has the ability to bundle services between wireless and MSO service providers which share a common subscriber.

One prior art approach to delivery of content comprises the so-called “Movielink” service. Movielink provides a 24-hour viewing period that begins when the user clicks “Play Movie” on the website. One can download a movie today and watch it next week (or up to 30 days later). One cane also store a movie for up to 30 days after the rental transaction. The user must use the 24-hour viewing period by end of a prescribed storage period. Additional 24-hour viewing periods are available for most rented movies without downloading again. One can start watching within 2-10 minutes of clicking “download” on the website, or store movies for later (average full download time is 30-90 minutes). There are no subscription or membership fees, and no rental returns, but rather direct (onetime) payment for each movie.

However, the terms of Movielink use do not permit burning or other copying of the content. Movielink also does not have any “VOD” or “PVRIDVR” capability during a download (streaming) play, nor does it provide streaming VOD capability on Movielink. This is significant for a “smartphone” or similar thin client devices, since they do not have a HDD or the like and unlikely can store entire movie or even video “short” in RAM or Flash memory Furthermore, prior art approaches such as Movielink are purely IP-based (packet switched PC or laptop via ISP or access point); no provisions for connecting this functionality to a cellular phone or smartphone, but rather only a laptop.

Another prior art approach known as “Easyshare Mobile” by Kodak allows users to upload and keep digital photos in a secure, personal, online Mobile Service account. Camera phone pictures can be sent to a designated location (i.e., save@kodakmobile.com) to be stored in their account. The uploaded photos and online albums can be shared with friends, family, etc. via access to the server. However, no capability to upload/download/share movie or video data is provided, and there is no linking to a content-based distribution system (e.g., cable or satellite network) or the subscriber billing accounts associated therewith.

Based on the foregoing, it is evident that improved apparatus and methods are needed to provide on-demand services between an existing MSO or satellite subscriber's content-based network and a cellular-based network, e.g., between the VOD server in a cable network and various types of client mobile devices. Such apparatus methods would ideally be able to utilize existing IP Multimedia Subsystem (IMS), WAP, or comparable existing infrastructure and protocols, and could provide the required functionality without requiring significant modifications or retrofits to existing system hardware. Such improved apparatus and methods would also permit correlation between a given subscriber's accounts on each network, thereby allowing for unified billing to that subscriber.

### SUMMARY OF THE INVENTION

The present invention addresses the foregoing needs by providing improved methods and apparatus for multimedia and data transmission within content-based networks such as cable and satellite networks, as well as mobile networks.

In a first aspect of the invention, a method of providing content services to a mobile device from a content-based network is disclosed. In one embodiment, the method comprises: establishing a communication link between the mobile device and an entity of the content-based network; transmitting a request for content from the mobile device to the entity; establishing a communication session between the mobile device and the entity in response to the request; and providing content from the entity to the mobile device over the communication link. The communication link is established using a session using the Session Initiation Protocol (SIP), SSP, or WAP/WSP and controlled using; e.g., a lightweight stream control protocol (LSCP) which also supports “trick mode” functionality in conjunction with an on-demand (e.g., VOD) server in a cable or satellite network. In one variant, the mobile network comprises a 3G UMTS network, and the IMS infrastructure thereof is utilized for at least portions of the bearer.

In a second aspect of the invention, apparatus for use with a cable network and adapted for the transmission of on-demand content is disclosed. In one embodiment, the apparatus comprises: at least one cellular base station adapted for communication with a client mobile device, wherein the cellular base station is in communication with a cellular service provider network; and a network interface in data communication with the cellular service provider network and the cable network, wherein the cable network comprises at least one on-demand server associated therewith. The at least one base station is adapted to pass on-demand content to the client mobile device, the on-demand content located on the at least one on-demand server, the content being sent through the cellular service provider network and the interface. The interface may comprise an IP gateway, cable modem termination system (CMTS), or other such device adapted to bridge between the HFC cable network and the bearer network for the cellular service provider.

In a third aspect of the invention, a client mobile device apparatus adapted to at least receive on-demand content is disclosed. In one embodiment, the apparatus comprises: a transceiver adapted to communicate with a network; a processor adapted to process at least a portion of on-demand content; a display element adapted to display at least the portion of the on-demand content; a storage device adapted to at least transiently store at least a portion of the on-demand content; and at least one computer program adapted to establish a multimedia session with an on-demand server.

In a second embodiment, the device comprises at least one computer program adapted to establish, at least alternately: (i) a multimedia session with an on-demand server; and (ii) delivery of packetized multimedia content from a server of a broadcast network.

In a fourth aspect of the invention, network server apparatus adapted to provide on-demand content over at least a portion of a network is disclosed. In one embodiment, the network server apparatus comprises: a processor; at least one computer program operable to run on the processor, the program being adapted to format on-demand content for transmission over a network; and a storage device in data communication with the processor and adapted to hold at least a portion of the on-demand content therein, the storage; wherein the network server is further adapted to transmit the on-demand content via at least a portion of a coaxial cable network and to a cellular service provider network for delivery to a mobile device.

In a fifth aspect of the invention, a method for providing on-demand content to a cellular network subscriber is disclosed. In one embodiment, the method comprises: initiating a multimedia session with an on-demand server by the subscriber using a mobile device; authenticating the subscriber using at least the cellular network; and billing the subscriber for accessing the on-demand content by the mobile device. In one variant, billing comprises billing a subscriber account that also includes charges for access to a cable television network. Session initiation is performed using at least one of the SIP, WAP (WSP) and SSP protocols.

In a sixth aspect of the invention, improved consumer premises equipment (CPE) is disclosed. In one embodiment, the CPE comprises: a radio frequency front end adapted to be in signal communication with a coaxial cable network coupled to at least one on-demand network server; a processor; at least one computer program operative to run on the processor, the at least one program being adapted to request and receive on-demand content from the at least one on-demand server so that it can be viewed by a subscriber on a display device; wherein the at least one program is further operative to access, in an on-demand fashion and after proper authentication, content stored on the at least one server from a mobile device owned by a third party.

In a seventh aspect of the invention, a method of assuring complete delivery of data to a mobile device serviced by a mobile network is disclosed. In one embodiment, the mobile network is in data communication with a content-based network and subject to periodic unpredictable dropouts, and the method comprises delivering the data from the content based network in an on-demand fashion including trick mode functionality, the on-demand and trick mode functionality cooperating to permit a user of the mobile device to selectively repeat delivery of at least portions of the data that would have otherwise not been received due to the dropouts in the mobile network.

In an eighth aspect of the invention, a method of doing business within both a content-based network and mobile network is disclosed. In one embodiment, the content-based network has a first set of subscribers and a mobile network has a second set of subscribers, at least some of the first set of subscribers also comprising the second set of subscribers so as to form a set of common subscribers, and the method comprises: providing services over the content-based network to the set of common subscribers; providing data or content delivery services over the mobile network to the set of common subscribers; and billing the services delivered to the same subscriber over the content-based network and the mobile network using a common billing mechanism. In one variant, the content-based network services comprise video-on-demand (VOD) services. In another variant, the services comprise Voice-over-IP (VoIP) telephony services.

### BRIEF DESCRIPTION OF THE DRAWINGS

FIG. 1 is a functional block diagram illustrating an exemplary network configuration useful with the present invention.

FIG. 1a is a functional block diagram illustrating one exemplary head-end configuration of the HFC network of FIG. 1.

FIG. 1b is a functional block diagram illustrating one exemplary broadcast switched architecture (BSA) useful with certain embodiments of the present invention.

FIG. 2 is a logical flow diagram illustrating one exemplary generalized methodology of providing on-demand video and data services over a network according to the invention.

FIG. 2a is a logical flow diagram illustrating one exemplary embodiment of the method for establishing a streaming multimedia session between the VOD server and CMD of FIG. 1.

FIG. 2b is a graphical representation of the method of FIG. 2a.

FIG. 2c is a graphical representation of the general process flow for the exemplary embodiment of the invention in the context of an HFC cable network with associated CSP or WSP.

FIG. 3 is a functional block diagram illustrating an exemplary embodiment of a client mobile device (CMD) according to the principles of the present invention.

FIG. 3a is a graphical representation of one exemplary protocol stack of the client mobile device of FIG. 3.

FIG. 4 is a functional block diagram of one exemplary embodiment of network server adapted for providing on-demand content to the CMD of FIG. 3.

FIG. 5 is a perspective view of one exemplary embodiment of a CMD display stand according to the invention.

FIG. 6 is a logical flow diagram illustrating one exemplary business method for establishing common billing between a MSO subscriber's home network and access to on-demand content through a client mobile device.

### DETAILED DESCRIPTION OF THE INVENTION

Reference is now made to the drawings wherein like numerals refer to like parts throughout.

As used herein, the terms “network” and “bearer network” refer generally to any type of telecommunications or data network including, without limitation, hybrid fiber coax (HFC) networks, satellite networks, telco or cellular networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.).

As used herein, the terms “MSO” or “multiple systems operator” refer to a cable, satellite, or terrestrial network provider having infrastructure required to deliver services including programming and data over those mediums.

As used herein, the term “head-end” refers generally to a networked system controlled by an operator (e.g., an MSO or multiple systems operator) that distributes programming to MSO clientele using client devices. Such programming may include literally any information source/receiver including, inter alia, free-to-air TV channels, pay TV channels, interactive TV, and the Internet. DSTBs may literally take on any configuration, and can be retail devices meaning that customers may or may not obtain their DSTBs from the MSO exclusively. Accordingly, it is anticipated that MSO networks may have client devices from multiple vendors, and these client devices will have widely varying hardware capabilities. Multiple regional head-ends may be in the same or different cities.

As used herein, the term “billing module” refers generally to an apparatus for keeping track of services provided to individual MSO subscribers or groups of subscribers, whether accessed by a CPE, CMD or otherwise, so that these services may be properly charged to the appropriate MSO subscriber account(s).

As used herein, the terms “client mobile device” and “CMD” include, but are not limited to, personal digital assistants (PDAs) such as the Apple Newton®, “Palm®” family of devices, handheld computers, personal communicators such as the Motorola Accompli or MPx 220 devices, J2ME equipped devices, cellular telephones such as the Motorola A845, “SIP” phones such as the Motorola Ojo, Apple iPod/iPod Nano, Motorola ROKR, personal computers (PCs) and minicomputers, whether desktop, laptop, or otherwise, or literally any other device capable of receiving on-demand video, audio or data with a network.

Similarly, the terms “Customer Premises Equipment (CPE)” and “host device” refer to any type of electronic equipment located within a customer's or user's premises and connected to a network. The term “host device” refers generally to a terminal device that has access to digital television content via a satellite, cable, or terrestrial network. The host device functionality may be integrated into a digital television (DTV) set. The term “customer premises equipment” (CPE) includes such electronic equipment such as set-top boxes, televisions, Digital Video Recorders (DVR), gateway storage devices (Furnace), and ITV Personal Computers.

As used herein, the term “network agent” refers to any network entity (whether software, firmware, and/or hardware based) adapted to perform one or more specific purposes. For example, a network agent may comprise a computer program running in server belonging to a network operator, which is in communication with one or more processes on a CPE, CMD, or other device.

As used herein, the terms “radio area network” or “RAN” refer generally to any wireless network including, without limitation, those complying with the 3GPP, 3GPP2, GSM, IS-95, IS-54/136, IEEE Std. 802.11, Bluetooth, WiMAX, IrdA, or PAN (e.g., IEEE Std. 802.15) standards. Such radio networks may utilize literally any air interface, including without limitation DSSS/CDMA, TDMA, FHSS, OFDM, FDMA, or any combinations or variations thereof.

As used herein, the term “ISA” refers to any of the existing or future variants of the Interactive Services Architecture Specification or related specifications, including without limitation ISA versions 1.4 and 1.5, each incorporated herein by reference in its entirety.

The term “on-demand content” refers to video, audio or other data that may be accessed through an MSO or other entity at the demand of the subscriber. While traditionally offering full-length features, other content such as, without limitation, music videos, promotional material, tutorials or virtually any type of data (audio, video or otherwise) can be provided in a session/on-demand fashion.

The term “processor” is meant to include any integrated circuit or other electronic device (or collection of devices) capable of performing an operation on at least one instruction including, without limitation, reduced instruction set core (RISC) processors, CISC microprocessors, microcontroller units (MCUs), CISC-based central processing units (CPUs), and digital signal processors (DSPs). The hardware of such devices may be integrated onto a single substrate (e.g., silicon “die”), or distributed among two or more substrates. Furthermore, various functional aspects of the processor may be implemented solely as software or firmware associated with the processor.

As used herein, the term “server” refers to any computerized component, system or entity regardless of form which is adapted to provide data, files, applications, content, or other services to one or more other devices or entities on a computer network.

As used herein, the term “package” refers to an arrangement of computer-readable data files or other data structures assembled to comply with a specific syntax or protocol.

As used herein, the term “provisioning” refers generally to a process whereby a package, content title or other information is provided to a service (such as on-demand download service) so that the information is integrated with other functions and software modules within the service.

As used herein, the terms “computer program”, “routine,” and “subroutine” are substantially synonymous, with “computer program” being used typically (but not exclusively) to describe collections or groups of the latter two elements. Such programs and routines/subroutines may be rendered in any language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™, Java Beans, and the like. In general, however, all of the aforementioned terms as used herein are meant to encompass any series of logical steps performed in a sequence to accomplish a given purpose.

As used herein, the term “application” refers generally to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could comprise a downloadable Java Xlet™ that runs within the JavaTV™ environment.

As used herein, the term “memory” refers to any type of data storage device including, without limitation, RAM (e.g., DRAM, SDDRAM, DDR, etc.), ROM, Flash (including NAND), EEPROM, magnetic bubble, optical, and so forth.

### Overview

The present invention provides, inter alia, apparatus and methods for accessing data (such as video, audio or data files) over a network according to download or “on demand” paradigms. In one embodiment, the network comprises a cable television network connected with a CSP (cellular service provider) or wireless service provider (WSP), and on-demand content delivery is accomplished via a “point-to-point” approach wherein a session is established between a content receiving entity (such as a cellular telephone) and a distributing entity (e.g., a VOD server). Session establishment and data flow control are advantageously implemented using protocols and bandwidth that are typically used for (i) providing on-demand services to subscribers within the cable network, and (ii) delivery and control of streaming multimedia to client mobile devices. This use of largely existing infrastructure and capability largely obviates any substantive modifications to the existing network infrastructure, yet provides several synergies as described in greater detail subsequently herein.

Using a session-based approach, multimedia or data sessions can be readily established, and then immediately terminated when the transfer is completed, thereby rapidly freeing up bandwidth on the network as with a conventional OD session. Similarly, other extant session and bandwidth management techniques may be used as if the mobile user (or wireless network to which he/she is connected) were merely a consumer premises device (CPE) or local hub in the cable network. The present invention may also be adapted for use with satellite or other types of content-based networks if desired.

In one embodiment, session establishment and data flow control are advantageously implemented using protocols and bandwidth that are typically used for delivery and control of streaming multimedia to a subscriber's CPE, such as a cable network's VOD infrastructure. The content delivered may be an MPEG transport stream, for example, in either standard definition (SD) at 3.75 Mbps, or high definition (HD) at 15 Mbps (or any increments or multiples thereof).

The receiving client device, via a fixed- or soft-function key or other such user interface, can invoke FF, REW or other “trick mode” functionality with respect to the video streamed over the wireless network (and any intermediate fiber/wired links within the IP network). This feature can also be used as a complement to other existing modalities, such as “real time” streaming or simply transferring the complete video/audio data file(s) to the requesting client for storage (and provision of “trick mode” functions) thereon.

The on-demand content provided to a subscriber's mobile device can be billed to the same MSO account held by the subscriber for the cable network services provided to the subscriber's premises. This allows for a convenient “bundling” of services, obviating a need to pay for access to this additional on-demand content on a separate bill or billing account. Prior art approaches such as Movielink previously described herein provide no linking of subscriber accounts; rather, payment is required via a credit/debit card or established account, similar to other online transactions.

Applications where the on-demand download capability of the present invention may be especially useful include on-demand downloading or streaming of movies, trailers, music videos or even a personal video created and placed onto the OD server or other providing network entity by the same or another MSO subscriber.

The on-demand access of content according to the invention is also advantageously agnostic to the type of session establishing protocol or data transfer protocol used, thereby allowing the transfer of content to a client mobile device over virtually any type of multimedia-capable cellular or wireless bearer network (including e.g., 3G, CDMA, TDMA, 802.11, etc.).

The present invention can make use of packet-over-circuit technologies to extend its reach; e.g., use of UMTS CDMA air interface, RAN, etc. Almost all current cellular phones have WAP or similar Internet access technology (which accesses distant WAP server site via a gateway or similar infrastructure), but these are generally not equipped to handle any significant download sizes due to very limited bandwidth. The exemplary use 3G IMS increases bandwidth significantly, and hence is a natural choice to carry video content (even streamed).

In another aspect, a type of “VoIP bundling” is provided. As is well known, VoIP is a packetized technology that is well adapted to packet media carriers, such as e.g., the 3G IMS. Hence, users of the present invention can make VoIP calls to/from their mobile device, and have it billed to their cable subscriber account, or not billed at all (in the case of a promotion or incentive or the like). For example, if the user makes a traditional cellular (circuit-switched) call, they may be billed on a per-minute basis, or via a plan that allocates X minutes per month. Either way, the user is paying a per-minute charge of sorts. Contrast the aforementioned VoIP call, wherein the CSP (under agreement with the MSO) may provide a reduced or different rate structure since call is being originated by MSO subscriber, and in part uses IP network of MSO (e.g., Family Member A calls Family Member B from their mobile at home over the MSO cable IP infrastructure and CSP infrastructure).

The present invention also advantageously provides for upload of content to a server or other network entity, and the uploaded content can then be downloaded and “VOD'd” by a linked subscriber, unlike prior art approaches (such as Movielink) that are one-way (download) in nature. For example, using a cellular phone camera, microphone, etc., user can stream video up to the VOD server for download/VOD access by others who have authorized access to the content-based network (perhaps other family members or friends), so these other persons can watch the uploaded content on their home TV or desired platform (e.g., PC).

### DETAILED DESCRIPTION OF EXEMPLARY EMBODIMENTS

Exemplary embodiments of the apparatus and methods of the present invention are now described in detail. While these exemplary embodiments are described in the context of the aforementioned hybrid fiber coax (HFC) cable system architecture connected through an IP Gateway to a Cellular Service Provider (CSP) having digital networking capability and a plurality of client mobile devices (CMDs), the general principles and advantages of the invention may be extended to other types of networks and architectures, whether broadband, narrowband, wired or wireless, satellite or cable, or otherwise, the following therefore being merely exemplary in nature. For example, these techniques could conceivably be employed in the context of a public switched telephone network (PSTN).

It will also be appreciated that while described generally in the context of a network providing service to a customer (i.e., cellular telephone user) end user domain, the present invention may be readily adapted to other types of environments including, e.g., commercial/enterprise, and government/military applications. For example, in time of war or emergency, the VOD/CSP infrastructure could be re-tasked for military, FEMA or homeland security use, such as to deliver informational or instructional video or other content. Myriad other applications are possible.

### System Architecture—

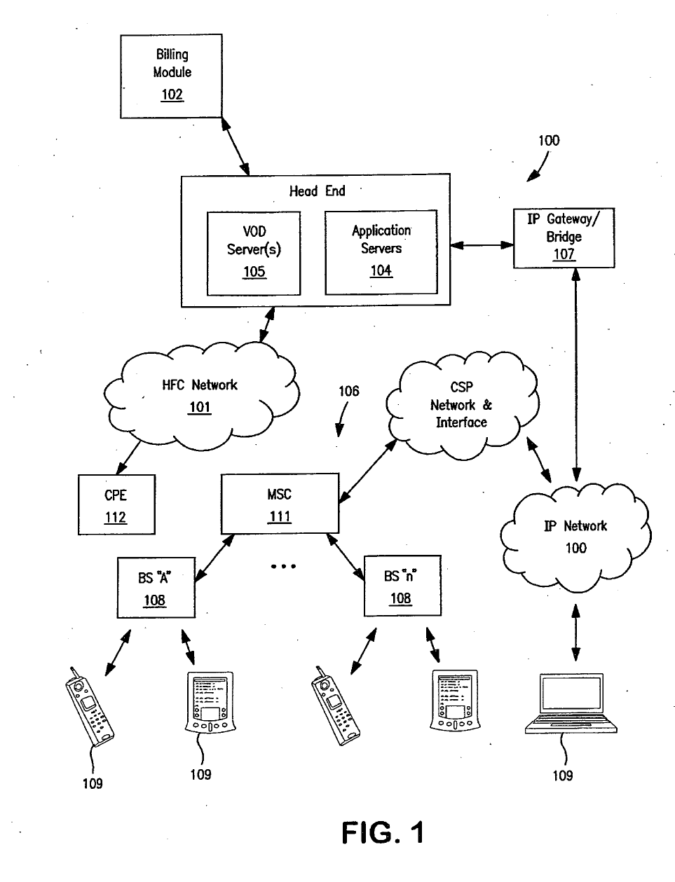

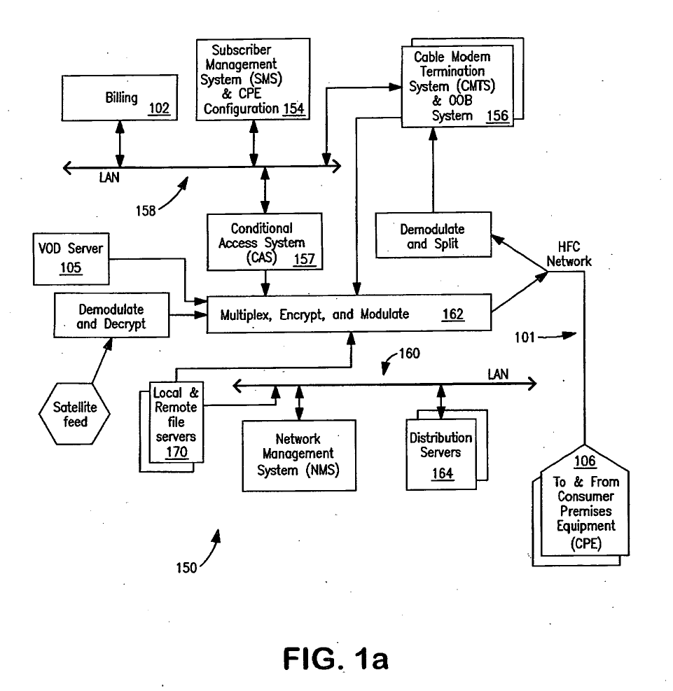

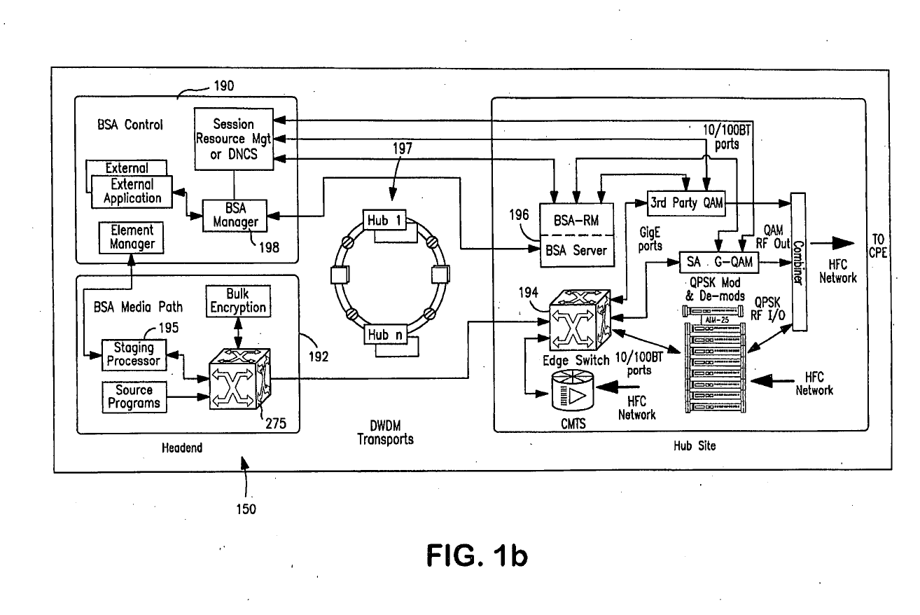

FIG. 1 illustrates a typical content-based network configuration with which the on-demand content services apparatus and methodology of the present invention may be used. The various components of the network 100 include (i) one or more data and application origination points (not shown); (ii) one or more content sources (e.g., third party studios or providers, networks, etc.); (iii) one or more application distribution servers 104; (iv) one or more VOD servers 105; (v) network “gateway” or bridge 107, and (vi) client mobile devices (CMD) 109. The distribution server(s) 103, 104, VOD servers 105 and CMD(s) 109 are connected via a bearer (e.g., Internet Protocol and CSP) network 106, 110. A subscriber or user billing module 102 is also provided. A simplified architecture comprising each of the aforementioned components 103, 104, 105, 106, 109 is shown in FIG. 1 for purposes of illustration, although it will be recognized that comparable architectures with multiple origination points, content and distribution servers, VOD servers, and/or CMD devices (as well as different network topologies) may be utilized consistent with the invention.

The application origination point comprises any medium that allows an application (such as a data download application or VOD-based application) to be transferred to a distribution server 104. This can include for example an application vendor website, CD-ROM, external network interface, mass storage device (e.g., RAID system), etc. Such transference may be automatic, initiated upon the occurrence of one or more specified events (such as the receipt of a request packet or ACK), performed manually, or accomplished in any number of other modes readily recognized by those of ordinary skill.

The content source 103 may comprise any indigenous (i.e., MSO) or third party provider of content, whether direct or indirect. This content may comprise an MPEG (e.g., MPEG-2) stream, or otherwise. The content may also pass through one or more intermediary nodes or conditioning process before transmission over the network 101 via a VOD server 105 or other device, as is well understood in the art.

The VOD server 105 is a computer system where on-demand content, as well as the data (discussed in greater detail below) can be received from one or more data sources and enter the network system. These sources may generate the content/data locally, or alternatively act as a gateway or intermediary from a distant source. The VOD server 105 includes the Session Resource Manager (SRM) functionality, and asks the Digital Network Control System (DNCS) for resources. The DNCS responds with negative or positive response to the request, and the VOD server implements the appropriate resource allocation logic.

The gateway or bridge 107 shown in FIG. 1 may comprise, e.g., a DOCSIS1.x or 2.x or EuroDOCSIS-compliant CMTS (cable modem termination system) or other such device. As is well known, the CMTS comprises devices typically located in the head-end or hub site that allows high-speed IP network access via the indigenous HFC subscriber network and CPE/cable modem. The CMTS performs a lower layer translation of sorts between the HFC domain in which the cable modem operates (e.g., 16- or 256-QAM RF channels) and the packet switched network domain, and also facilitates coupling to an internet or IP backbone (such as via an ISP, or directly by the MSO). Typical network layer protocols used by the CMTS and packet switched domains include IP (Internet Protocol), for compatibility between the two domains. Hence, with a cable modem and CMTS, a cable subscriber can couple his/her TCP/IP-based computer to the cable modem, and both transmit and receive IP-based packets via the CMTS interface to an external IP backbone (and hence the Internet) or other data network. Quality of Service (QoS) with minimum and maximum rate service levels may also be provided, as well as inter alia link- or other-layer encryption and key management protocol, dynamic load balancing and frequency agility, support of multiple upstream and downstream channels, remote access server (RAS) capability, anti-spoofing functions, per subscriber filters, per cable modem DHCP assignments and per cable modem maximum number of subscribers.

Since content delivery is often in the form of a packetized protocol (e.g., MPEG2 or the like), the CMTS or other bridge device to the external IP network can also take the packetized content directly from the server (after proper formatting, FEC, etc. as required) and vice versa.

Alternatively, the gateway/bridge 107 may comprise other devices adapted to provide internet/intranet/WAN/LAN/MAN/piconet connectivity outside the HFC domain, such as a protocol translator/packetizer coupled to a millimeter wave link for transmission to a distant location. Many possible configurations for the interface between the HFC and packet-switched networks are possible consistent with the invention, including those which provide AP/DS/ESS functionality in IEEE Std. 802.11 systems, H.323/VoIP gateways, and so forth. The present invention should in no way be considered limited to any particular style, configuration, location, or protocol of gateway or bridge.

Referring now to FIG. 1a, one exemplary embodiment of a head-end architecture useful with the present invention is described. As shown in FIG. 1a, the head-end architecture 150 comprises typical head-end components and services including billing module 152, subscriber management system (SMS) and CPE configuration management module 154, cable-modem termination system (CMTS) and OOB system 156, as well as LAN(s) 158, 160 placing the various components in data communication with one another. It will be appreciated that while a bar or bus LAN topology is illustrated, any number of other arrangements as previously referenced (e.g., ring, star, etc.) may be used consistent with the invention. It will also be appreciated that the head-end configuration depicted in FIG. 1a is high-level, conceptual architecture and that each MSO may have multiple head-ends deployed using custom architectures.

The architecture 150 of FIG. 1a further includes a multiplexer/encrypter/modulator (MEM) 162 coupled to the HFC network 101 adapted to “condition” content for transmission over the network. In the present context, the distribution servers 104 are coupled to the LAN 160, which provides access to the MEM 162 and network 101 via one or more file servers 170. The VOD servers 105 are coupled to the LAN 160 as well, although other architectures may be employed (such as for example where the VOD servers are associated with a core switching device such as an 802.3z Gigabit Ethernet device). As previously described, information is carried across multiple channels. Thus, the head-end must be adapted to acquire the information for the carried channels from various sources. Typically, the channels being delivered from the head-end 150 to the CPE 112 (“downstream”) are multiplexed together in the head-end and sent to neighborhood hubs (not shown).

Content (e.g., audio, video, etc.) is provided in each downstream (in-band) channel associated with the relevant service group. As will be discussed in greater detail subsequently herein, high-speed data is also provided over in-band channels, while associated metadata files are provided either in-band or out-of-band (OOB). To communicate with the head-end, the CPE 112 uses the OOB or DOCSIS channels and associated protocols. The OCAP 1.0 specification provides for networking protocols both downstream and upstream.

It will also be recognized that the multiple servers (OD or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

One exemplary multi-server architecture particularly useful with the present invention is described in co-pending and co-owned United States Patent Application Publication No. 20020059619 to Lebar published May 16, 2002 and entitled “Hybrid central/distributed VOD system with tiered content structure” which is incorporated herein by reference in its entirety. Specifically, a hybrid central/distributed and tiered video on demand (VOD) service network with tiered content structure is disclosed. In particular, the system uses media servers located in both the head-end and hub stations. Set-top boxes (or CMD) generally would be supplied VOD services from the high-demand content media (and data) servers located in the hub station nearest to the user (or the Gateway). The central media server located in the head-end would be used as an installed backup to the hub media servers; as the primary source for lower demand VOD services and as the source of the real time, centrally encoded programs with PVR (personal video recorder) capabilities. By distributing the servers to the hub stations, the size of the fiber transport network associated with delivering VOD services from the central head-end media server is reduced. Hence, each user has access to several server ports located on at least two servers. Multiple paths and channels are available for content and data distribution to each user, assuring high system reliability and enhanced asset availability. Substantial cost benefits are derived from the reduced need for a large content distribution network and the reduced storage capacity requirements for hub servers.

It will also be recognized that a heterogeneous or mixed server approach can be utilized consistent with the invention. For example, one VOD server configuration or architecture may be used for servicing cable subscriber CPE-based session requests, while a different configuration or architecture may be used for servicing mobile client requests. Similarly, servers can either be single-purpose or dedicated (e.g., where a given server is dedicated only to servicing certain types of requests), or alternatively multi-purpose (e.g., where a given server is capable of servicing requests from multiple different sources).

Furthermore, it is noted that the VOD server 105 (or other servicing entity tasked with session establishment/management for CMDs) can be integrated or included within rules or optimization algorithms running on the traditional server processes. For example, the CMD bandwidth/session number requirements, which are anticipated to vary significantly as a function of time or other parameters as is true of VOD. Hence, these variations, and their potential impact on the larger cable plant, can be integrated into bandwidth optimization and conservation algorithms of the type well known in the art, thereby accounting for the CMD servers as if they were merely another VOD server for downstream CPE. Alternatively, the VOD servers 105 servicing CPE requests can be made “double duty” so as to handle both CMD and CPE session requests and content delivery, thereby further integrating the CMD services with normal cable plant services, and also including the CMD services within bandwidth optimization/conservation processes indigenous to the network. Also, the CMD services and sessions can be included within any statistical multiplexing algorithms.

The OD server can also be made to support multiple session protocols such as SIP, WASP/WSP, and SSP, thereby allowing it to be substantially agnostic to session requests received from heterogeneous types of CMDs (assuming sufficient capabilities are negotiated and present for transfer of the desired content).

Alternatively, CMD services can be kept entirely separate of the extant cable plant, and separate optimization/multiplexing algorithms employed if necessary.

Many other permutations of the foregoing system components, architectures and communication methods may also be used consistent with the present invention, as will be recognized by those of ordinary skill in the field.

The CMD 109 includes any device capable of requesting and receiving streaming (or downloaded) media, such media being accessible by a distribution server 104 via a cellular service provider 106 or other IP network 110. Such CMDs 109 comprise processors and associated computer memory (and optionally mass storage) adapted to store and/or run the downloaded or resident application, as well as receive (and optionally store) streamed content and data. In the present context, at least a portion of the CMD application necessary to facilitate streaming on-demand content (or download) can itself be downloaded to the CMD 109, wherein the latter executes the downloaded application(s)/components in order to enable the CMD to receive the on-demand content, although it will be recognized that the application(s) may also be resident on the CMD before download, received from another source (such as a third party Internet site, CD-ROM, etc.), and so forth. For example, the MSO or other entity may operate an Internet web site which allows their subscribers to access a downloadable “thin” client application to facilitate content streaming to the mobile device.

A CSP 106 (cellular service provider) provides mobile communication system services to cellular services subscribers. CSPs include such companies as Verizon®, Cingular® and T Mobile® which carry voice and data over a network which can then deliver this voice and data to a client mobile device 109, and similarly receive data from mobile units and pass it to its destination (which may be another mobile unit, a POTS based user, a server, etc.). The term cellular refers to communications systems that essentially divide a geographic region into individual regions or cells.

The Mobile Switching Center (MSC) 111 is a sophisticated telephony and data exchange which provides circuit-switched and/or packet-switched calling (i.e., mobility management and services) to the client mobile devices 109 roaming within the area that it serves. For example, this mobility management and services includes such things as voice, data and fax, as well as short message service (SMS) and call divert. The MSC routes data and services to the appropriate base station(s) 108 servicing the particular CMD 109 at a given point in time.

Base stations 108 are essentially low-power multi-channel two-way radios which are in a fixed location. They are typically used by low-power single-channel, two-way client mobile devices 109 (e.g., cellular telephones, PDAs, etc.). The base station 108 is essentially the wireless link between a CMD 109 and a land-based network for routing voice and data between the two. Base stations are well understood in the wireless arts, and as such will not be discussed further herein.

A wireless servce provider (WSP), sometimes also referred to as a WISP (wireless Internet service provider), generally provides wireless access to broadband or similar capabilities through a network of access points (such as the IEEE Std. 802.11 Access Points) located in areas such as libraries, Internet cafes, and other public gathering locations. Access from a given user's mobile device (e.g., laptop computer, PDA, etc.) through the access point (gateway) to a local broadband connection, the latter which provides Internet or other desired connectivity. For example, another use of such access point is for enterprise applications, wherein mobile users are able to access a corporate internet or LAN/WAN.

Similarly, the WSP may utilize WiMAX or similar technology for implementation of its wireless air interfaces. “WiMAX” is a wireless technology that provides high-throughput broadband connections over longer distances (as compared to short-range technologies such as Bluetooth or PAN). WiMAX can be used for a number of applications, including “last mile” broadband connections, cellular backhaul, hotspot coverage, and high-speed enterprise connectivity. WiMAX systems include those conforming to IEEE Std. 802.16-2004 and ETSI BRAN HiperMAN.

It will also be recognized that the present invention may be configured with one or more short-range wireless links such as Bluetooth for lower bandwidth applications. As is well known, Bluetooth comprises a comparatively low bandwidth (e.g., up to about 3 Mbps in extant configurations), short range, piconet-based two-way FHSS architecture that allows pairing/bonding between local Bluetooth devices. Hence, the CMD 109 may comprise a Bluetooth equipped device, while an intermediary device (e.g., cellular telephone, WiFi gateway, etc.) is used to connect to the CSP/WSP infrastructure. It is also noted that many cellular telephones and other devices (such as the Motorola RAZRV3 and the like) include both a Bluetooth and cellular transceiver, which can be configured to couple data between the two interfaces. Hence, in one example, a cellular or WiFi device could act as gateway for multiple Bluetooth client devices via a piconet, the Bluetooth client devices receiving the streamed/downloaded content from the gateway via thir respective Bluetooth interfaces.

In another variant, a dynamic compensation mechanism is implemented via a SIP- or WAP-over-Bluetooth configuration, such as where two Bluetooth-equipped mobile devices have paired (authenticated) and are exchanging streaming video data over the Bluetooth bearer link within a Master-Slave relationship or piconet. Synchronization between the two client applications on the respective devices may be accomplished using any number of available protocols, including for example the well-known SyncML protocol now ubiquitous on many cellular telephones and PDAs. Literally any bearer network (physical layer) may be utilized for this purpose, including for example WiFi (IEEE-802.11) or the like. Hence, users having access to WiFi hotspots can establish a relationship with the local AP (802.11) or Master (Bluetooth) and bridge to an IP network which is then coupled to the HFC network via IP backbone, CMTS, etc. as previously described.

Each CPE 112 comprises a processor and associated computer memory (and optionally mass storage) adapted to store and run the downloaded or resident application, as well as receive and store the streamed content and data. In the present context, at least a portion of the CPE application necessary to facilitate receipt of on-demand content can itself be downloaded to the CPE 112, wherein the latter executes the downloaded application(s)/components in order to enable the CPE to receive the on-demand content, although it will be recognized that the application(s) may also be resident on the CPE before download, received from another source (such as a third party Internet site, CD-ROM, etc.).

The bearer network(s) of the present invention may also be equipped with PacketCable or PCMM capability as well. Whereas PacketCable 1.x only supports the delivery of IP telephony services via Network Call Signaling (NCS), PCMM enables a wide range of applications via DOCSIS 1.1/2.0 access networks, such as Session Initiation Protocol (SIP) telephony, video telephony, multi-player gaming, and streaming media services. Using PCMM, a client device (e.g., CMD 109 or CPE 112), such as a 3G cellular phone, videophone or a game console, registers with a PCMM application manager. Once the device and its services are authorized, the application manager communicates with a PCMM policy server to specify the quality-of-service (QoS) that should be applied. The policy server communicates with the DOCSIS1.1/2.0 CMTS, which guarantees that the needed bandwidth and latency are available for the services across the access network.

### PTT/PTx and Other Variants—

In another embodiment of the invention, a SIP (Session Initiation Protocol) enabled device or comparable is used to establish a secure user session to transmit the required information. In one variant, a “PoC” (push-to-talk {PTT} over cellular) approach is used, wherein the user's mobile device includes an architecture that supports instantaneous communications via, e.g., the aforementioned SIP protocol layered over a UMTS IMS architecture of the type well known in the communications arts. For example, the user's client process can be configured to instigate a PoC session upon the user selecting the proxy or application server as a “buddy” and invoking a PTT transmission. So-called “PTx” or “push-to-anything” technology may be used for this purpose; e.g., pre-formatted packages of data necessary to perform content upload/download management or related functions (including, e.g., subscriber authentication) can be immediately transmitted to the desired receiver via a one-button transmit functionality. These packets may be encapsulated for security purposes, e.g., via an application layer or other protocol such as Digest, IPSec, MIKEY, etc. Alternatively, where Bluetooth is utilized, the proxy or application server can conduct an (e.g., user-permissive) object pull according to the K-11 or OBEX profiles.

### Switched Digital Variants—

While previously described in the context of VOD or other on-demand network paradigms, it will be appreciated that the invention can also be adapted to operate with broadcast type network paradigms, such as the so-called “switched digital” or “broadcast switched” architectures of the type well known in the art, such as the exemplary configuration shown in FIG. 1b. Such switching architectures allow improved efficiency of bandwidth use for ordinary digital broadcast programs. Specifically, as shown in FIG. 1b, the exemplary network comprises a fiber/coax arrangement wherein the downstream signals are transferred to the optical domain (such as via an optical transceiver 177 at the head-end or further downstream). The optical domain signals are then distributed to a fiber node 178, which further distributes the signals over a distribution network 180 to a plurality of local servicing nodes 182. This provides an effective 1:N expansion of the network at the local service end.

The head-end 150 contains switched broadcast control and media path functions 190, 192; these element cooperating to control and feed, respectively, downstream or edge switching devices 194 at the hub site which are used to selectively switch broadcast streams to various service groups. A broadcast switching (BSA) server 196 is also disposed at the hub site, and implements functions related to anticipatory switching and bandwidth conservation (in conjunction with a management entity 198 disposed at the head-end). An optical transport ring 197 is utilized to distribute the dense wave-division multiplexed (DWDM) optical signals to each hub in an efficient fashion.

Co-owned and co-pending U.S. patent application Ser. No. 09/956,688 filed Sep. 20, 2001 and entitled “Technique For Effectively Providing Program Material In A Cable Television System”, incorporated herein by reference in its entirety, which describes one exemplary switched architecture useful with the present invention, although it will be recognized by those of ordinary skill that other approaches and architectures may be substituted.

BSA programming may comprise, without limitation, simulcasts, interactive pay-per-view (IPPV), live sporting and other events, and other selected offerings. A set-top box (STB) or two-way Digital Cable Ready (e.g., CableCard) television is typically required for viewing; however, in the present invention, the requisite functionality of these devices can be readily incorporated within the subscriber's mobile device (e.g., cellular phone or PDA).

Like video-on-demand (VOD) systems, BSA programs are streamed to a service group (contrast: switch) only when being viewed. Unlike VOD, many viewers can view the same stream. Typically, only real-time linear programs are included in BSA broadcasts. Since there is no storage involved, the “VCR” controls (e.g., trick mode functions) common to VOD are not available. In this regard, BSA is much simpler that VOD. Commercials or other programming segments cannot be skipped, and program bit rates are treated as in more conventional systems.

These “switched digital” or BSA networks can co-exist in tandem with the aforementioned OD architectures as well. For example, rather than being able to only initiate an OD session as previously described, the subscriber handset or other mobile device can also receive and play MPEG-2, advanced video codec (AVC), H.264 or similar encoded media streams transmitted in a broadcast fashion. Hence, the subscriber can switch between broadcast and OD paradigms, somewhat analogous to so-called “dual mode” cellular phones being equipped for two distinct air interfaces (such as CDMA and GSM) and able to switch between the two, except with respect to the content-based network delivery paradigm versus the air interface. These different paradigms could also form the basis of a business model, such as where broadcast content is delivered at a reduced (or no) charge as compared to the more premium VOD stream(s).

When multicast (e.g., to multiple subscribers at once), the broadcast stream can also act much as it does in the switched digital/cable environment; i.e., multiple parties can watch the same stream simultaneously, whereas VOD is basically a point-to-point technology due to trick mode functions and the like.

In one embodiment, the mobile subscriber acts just like another CPE 112 of sorts; i.e., the BSA server 196 and network will switch accordingly in order to deliver streams that are “flooded” to the BSA switch to the service group. For example, in a typical BSA network, bandwidth is conserved by effectively turning off streams (via the switch) when no subscribers are tuned to them. Similarly, the BSA server 196 can treat mobile-originated tuning requests in similar fashion; if one exists, the stream will be left “switched on” for delivery from the hub site to the mobile device (via the interposed packet and circuit-switched networks). If no such request exists, then that stream can be “turned off.”

The broadcast switched signal delivered to the mobile units can also be originated from a separate “hub” (e.g., node on the DWDM ring 197) if desired, or even using other approaches. The mobile subscriber's can also be partitioned into a separate service group of sorts, with their own dedicated BSA control and switching architecture.

### Methods—

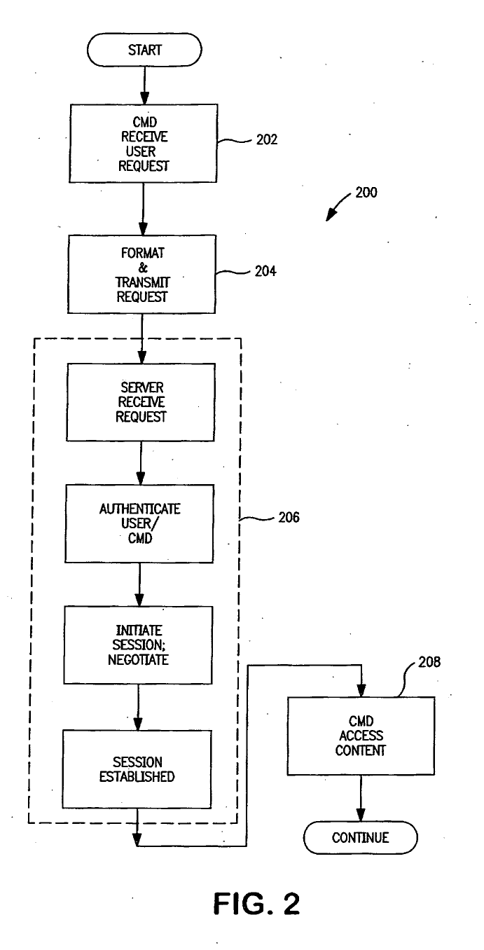

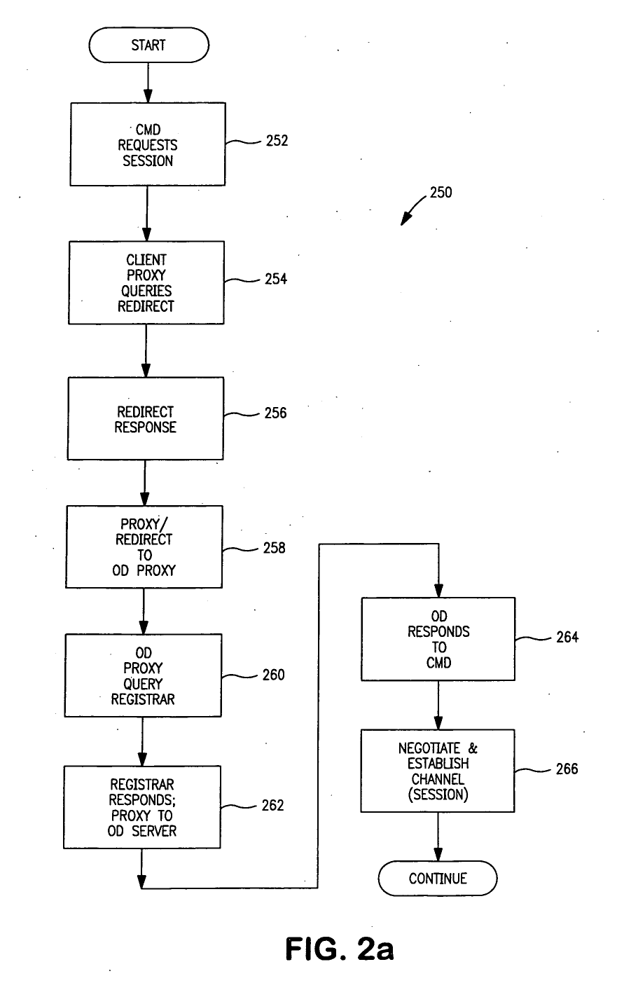

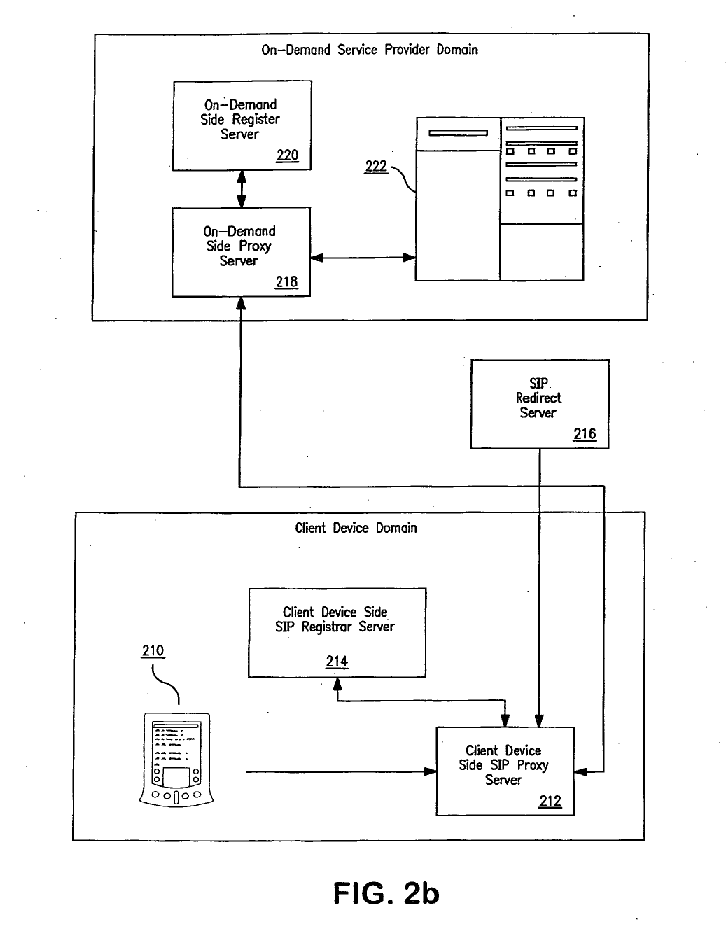

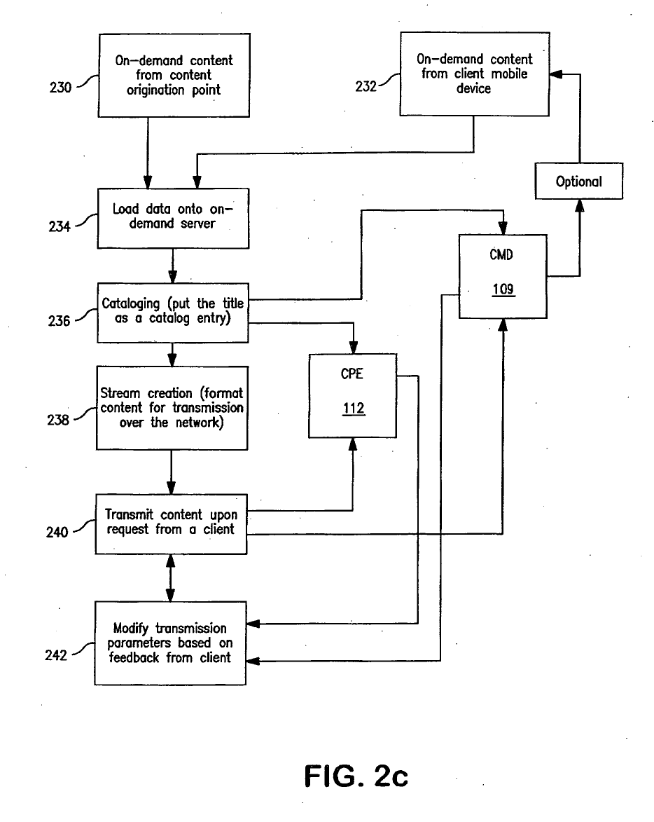

Referring now to FIG. 2, one exemplary generalized methodology of providing on-demand video and data services over a network is described. It will be recognized that the steps shown in the embodiment of FIG. 2 are high-level logical steps applicable to literally any on-demand (e.g., VOD) architecture, and are not intended to require or imply any specific process flow that may occur within particular implementations of the method. In practical embodiments, some of these steps (or sub-steps within each step) may be implemented in parallel, on different hardware platforms or software environments, performed iteratively, and so forth.

In step 202 of the method 200, the mobile device (CMD) receives a user request to initiate a session via the user interface (UI) or other mechanism associated with the CMD. For example in one variant, the CMD comprises a menu-driven video player application running on a cellular “smart phone” which receives user input via the soft- and/or fixed-function keys of the phone. This input causes the application to generate a session request message, which is passed down the various layers of the phone protocol stack and formatted for transmission via the phone's air interface/PHY (e.g., CDMA link). The mobile device initiates the session with the network server using a session establishing protocol such as SIP, although it will be recognized that other types of protocols can be utilized for this purpose.

Per step 204, the session request message is transmitted over the air interface to the base station or wireless gateway to the interposed CSP/WSP infrastructure (e.g., MSC, IP backbone, gateways, routers, etc.) and ultimately to the IP interface (e.g., CMTS, bridge, etc.) at the edge of the MSO network.

In step 206, the VOD server (or another network proxy, such as a hub or serving node) establishes the requested session with the mobile device. The exemplary embodiment of the server comprises a session layer protocol (e.g., SIP) within its protocol stack and a TCP/IP transport/network layer adapted to respond to and/or establish user sessions with mobile clients which have been authenticated and authorized by the MSO. Intrinsic to this process is also any requisite authorizations/authentication associated with the CSP/WSP network, such as for example the security negotiations and authentication conducted in the aforementioned 3G networks. As is well known, the exemplary session initiation protocol (SIP) comprises a series of negotiations or communications between the relevant entities in order to establish a session which can then be used as a bearer for voice, data, multimedia, etc. communications between the entities.

In step 208, upon authentication and authorization by the MSO/CSP/WSP as applicable, and proper session initiation, the client mobile device can then access streaming video content via their mobile device over their indigenous bearer cellular network (3G/UMTS, CDMA, 3GPP2, or otherwise), the latter being coupled at its core (i.e., inside of the RAN/SGSN, etc.) to an IP backbone which is accordingly coupled to the MSOs content-based network via, e.g., the CMTS. In an alternative embodiment, the streaming/on-demand content can be requested over a traditional IP network via a mobile device such as a PDA or laptop computer. The HFC network can also optionally comprise an (home location register) HLR function and be considered the subscriber's “home network” for purposes of 3G authentication and provisioning.

Referring now to FIGS. 2a-2c, one exemplary embodiment of the method of FIG. 2 is described in detail. In this embodiment, the method comprises establishing a session between one or more clients in a 3GPP system. While discussed primarily in the context of the Session Initiation Protocol (SIP) and 3G system, other session-based media protocols (e.g., WAP Session Protocol or WSP, within WAP 1.x or 2.0 or subsequent variants, or SSP) and network architectures could be used in accordance with the principles of the present invention. Accordingly, as SIP has been (and continues to increasingly be) adopted in a variety of applications such as 3G UMTS “smartphone” technology, it is therefore chosen as a protocol well suited to illustrate the underlying concepts and principles of the present invention.

SIP is specified by the Internet Engineering Task Force (IETF) and comprises a highly generalized and widely applicable protocol for establishing user sessions across packet networks. SIP affords the capability for users to establish sessions which can transfer multimedia data, including for example voice, video, and audio, between two or more participants. The session is established according to a specified protocol including “invite” messages issued from a client requesting access to an asset on another device (“server”).

At the most general level, SIP sessions utilize up to four major components: (i) SIP User Agents which are the end-user devices, such as cell phones, multimedia handsets, PCs, PDAs, etc. used to create and manage a SIP session (i.e., CMDs 109 in the present invention); (ii) SIP Registrar Servers which are databases that contain the location of all User Agents within a particular domain; in SIP messaging, these servers retrieve and send participants' IP addresses and other pertinent information to the SIP Proxy Server; (iii) SIP Proxy Servers accept session requests made by a SIP UA and query the SIP Registrar Server to obtain the recipient UAs addressing information; the session invitation is then forwarded directly to the recipient UA if it is located in the same domain or to a Proxy Server if the UA resides in another domain; and (iv) SIP Redirect Servers which allow SIP Proxy Servers to direct SIP session invitations to external domains. SIP Redirect Servers may reside in the same hardware as SIP Registrar Servers and SIP Proxy Servers. Together, these systems deliver messages embedded with the SDP protocol defining their content and characteristics to complete a SIP session.

IMS (IP Multimedia Subsystem) is an internationally recognized standard that specifies interoperability and roaming between devices and provides bearer network control and security. It is also well integrated with existing voice and data networks, and hence makes IMS an important enabling technology for fixed-mobile devices. IMS also makes efficient use of existing circuit- and packet-switched technologies.

In the context of a streaming multimedia session, the 3G IMS comprises a core network subsystem within the Universal Mobile Telecommunication System (UMTS), which uses the Session Initiation Protocol (SIP) to initiate, modify and terminate multimedia sessions. IMS also uses the IETF Session Description Protocol (SDP) to define session parameters, as well as negotiate codecs to be used during the multimedia session.

SIP runs atop different transport protocols such as the User Datagram Protocol (UDP) and the Transmission Control Protocol (TCP), and hence typically is implemented at the Session Layer. The IMS architecture (specified in 3GPP TS 23.22829) is built upon the UMTS packet domain. However, the IMS architecture is purposely designed so as to be forward-compatible with mechanisms for IP connectivity other than those utilized by the UMTS packet domain. This feature is known as “access network independence”, and also affords a significant degree of flexibility and forward compatibility to the present invention. For example, in the context of security, the generalized IETF architecture of SIP allows several security/trust models to be defined, providing hop-by-hop, end-to-middle and end-to-end security solutions. The IETF SIP working group has accordingly defined several security mechanisms that can be applied to the different uses of SIP. These mechanisms offer, for example, authentication, message integrity, confidentiality, and replay protection.

It is noted that SIP requests and responses generally cannot be fully encrypted or protected for integrity on an end-to-end basis since parts of the messages by definition must be made available to intermediary entities (e.g., proxies) for routing purposes, and to permit modification of the messages. At the application layer, it is possible to use HTTP (HyperText Transfer Protocol) authentication and S/MIME (Secure/Multipurpose Internet Mail Extensions), since SIP carries MIME components. S/MIME has the disadvantage that it is based on public key certificates, and may in some instances result in the generation of very large messages (which are ideally avoided over a wireless channel due to bandwidth considerations). At the lower layers (e.g., transport and network) of the protocol stack, either TLS (Transport Layer Security) or IPsec can be used to secure the entire SIP message. Both UDP and TCP may be used in IMS, with UDP being the default protocol).

A 3GPP IMS subscriber has one IP multimedia private identity (IMPI) and at least one IP multimedia public identity (IMPU). To participate in multimedia sessions, an IMS subscriber must register at least one IMPU with the IMS. The private identity is generally used only for authentication purposes.

There are several IMS “entities” that are generally relevant to the 3G IMS architecture, including:

1) UE: The user equipment (UE) contains the SIP user agent (UA) and the smart card based IMS subscriber identity module (ISIM), an application that contains the IMS security information. The ISIM can be a distinct application sharing no data and functions with the USIM, or it can share data and security functions with the USIM or it can be a reused USIM. There can only be one ISIM per IMPI. The UE may comprise, for example, the CMD 109 previously described herein,

2) P-CSCF: The proxy call session control function. (P-CSCF) acts as an outbound SIP proxy. For the UA in the UE, it is the first contact point in the serving network. It forwards SIP requests towards the I-CSCF. This may be located, for example within the RAN or at the edge of the RAN in a 3G network.

3) I-CSCF: The interrogating call session control function. (I-CSCF) is the contact point in the home network and acts as a SIP proxy. It forwards SIP requests or responses towards a S-CSCF. This device or process may be located at any number of different locations, including the CSP cellular network.

4) S-CSCF: The serving call session control function. (S-CSCF) may behave as a SIP registrar, a SIP proxy server and a SIP UA. Before the UE can send a SIP INVITE message to invoke a session, it must first register an IMPU with the S-CSCF. The registration of an IMPU is accomplished by the UE by sending a SIP REGISTER message towards the home network.

Sessions are established using INVITE messages. In one scenario, an INVITE message is sent from one UE (e.g., CMD 109) to another, both of which reside in a 3GPP network. The INVITE from UE A in the first Home Network first passes through a P-CSCF and then to an I-CSCF, which forwards the message to the home subscriber system (HSS), which looks up to which S-CSCF the user is registered. A similar process is performed within the second Home Network, and the INVITE message is terminated in UE B. The IMS transmission may now start, for example, by using the IETF Realtime Transport Protocol (RTP).

The Wireless application protocol (WAP) is an application environment and associated set of communication protocols for wireless devices that is designed to enable manufacturer- and technology-independent access to advanced telephony services as well as the Internet.

WAP is designed to be independent of the network, bearer, and terminal used. Mobile subscribers can access substantially the same information from a mobile device as they can from the desktop. The WAP specifications define a set of protocols in application, session, transaction, security, and transport layers. WAP also defines a wireless application environment (WAE) aimed at enabling the development of advanced services and applications including for example “micro-browsers”, scripting facilities, World Wide Web (WWW)-to-mobile-handset messaging, e-mail, and mobile-to-fax access. Based on the Internet model, the mobile wireless device contains a micro-browser, while content and applications are hosted on Web servers.

WAP Applications are often written in wireless markup language (WML), which is a subset of extensible markup language (XML), and uses substantially the same model as the Internet. WAP utilizes Internet standards such as the user datagram protocol (UDP), and Internet protocol (IP). Many of the protocols are based on Internet standards such as hypertext transfer protocol (HTTP) and TLS, yet have been optimized for the unique constraints of the wireless environment (e.g., lower bandwidth, higher latency, and less connection stability/dropouts).

Internet standards such as hypertext markup language (HTML), HTTP, TLS and transmission control protocol (TCP) are generally inefficient over mobile networks, requiring larger amounts of data to be sent. Standard HTML content cannot be effectively and completely displayed on the small-size screens of mobile devices.

WAP utilizes a substantially binary transmission for greater compression of data, and is optimized for long latency and low bandwidth. The WAP HTTP interface serves to retrieve WAP content from the Internet that has been requested by the mobile device. WAP sessions are adapted to cope with intermittent coverage, and can operate over a wide variety of wireless transport mechanisms.

WML and wireless markup language script (WMLScript) are used to produce WAP content. They make optimal use of smaller mobile device displays, and navigation may be performed more easily (due to limited input devices on a mobile device). WAP content is substantially scalable; i.e., from a two-line text display on a basic device to a full graphic display screen.

A lightweight WAP protocol stack is specifically designed to minimize the required bandwidth, and maximize the number of wireless network types that can deliver WAP content. In that WAP is based on a substantially scalable layered architecture, each layer can develop independently of the others. This approach facilitates the introduction of new bearers or to use new transport protocols without major changes in the other layers of the stack.

In operation, a request from the mobile device is sent as, e.g., a URL through the wireless operator's network to the associated WAP gateway, which is the interface between the operator's network and the Internet (e.g., IP backbone).

The WAP datagram protocol (WDP) comprises the transport layer that sends and receives messages via any available bearer network, including IMS, SNIS, USSD, CSD, CDPD, IS-136 packet data, GPRS, etc.

Wireless transport layer security (WTLS) comprises an optional security layer, and has encryption facilities that provide the secure transport service required by many applications such as e-commerce.

The WAP transaction protocol (WTP) layer provides transaction support, adding reliability to the datagram service provided by WDP.

The WAP session protocol (WSP) layer comprises a lightweight session layer that allows for session establishment and the exchange of data between applications.

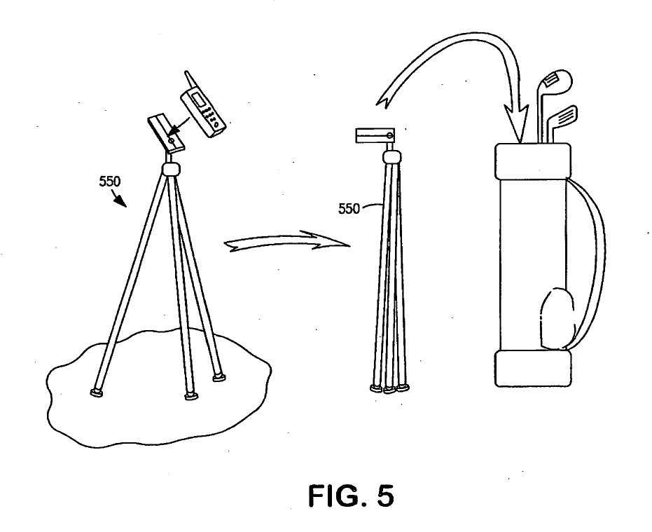

WAP content (WML and WMLScript) is converted into a compact binary form for transmission over the air The WAP microbrowser software within the mobile device interprets the byte code and displays the interactive WAP content (see FIG. 5).

Referring again to FIG. 2a, the method 250 utilizes a SIP session that is established between a client mobile device and a VOD server, although it will be recognized that other types of session and environments may be used (including WAP/WSP). First, a client mobile device 109, such as a Motorola® A845 UMTS videophone, makes a request to establish a SIP or other session with a VOD server 105 (step 252). The VOD server 105 (or another network proxy, such as a hub or serving node) has a session layer protocol (e.g., SIP, Session Setup Protocol (SSP), or other) within its protocol stack and a TCP/IP transport/network layer adapted to respond to and/or establish user sessions with mobile clients which have been authenticated and authorized by the MSO. Per step 254, a Query is made to the SIP Redirect Server 216 from the Client Device Side SIP Proxy Server 212 essentially asking for directions in order to establish a session with the VOD server 105.

Next, per step 256, the SIP Redirect Server 216 responds to the Client Device Side SIP Proxy Server 212 with the address of the proxy controller for the on-demand service provider domain. The Client Device Side SIP Proxy Server 212 is then ‘proxied’ to the On-Demand Side Proxy Server 218 (step 258). The On-Demand Side Proxy Server 218 then queries the On-Demand Side Registrar Server 220 for the address of the VOD Server 105 for which a session is being initiated (step 260). A response is given back to the On-Demand Side Proxy Server 218 and the request is proxied to the VOD server 105 (step 262). A response is then sent back towards the client mobile device 109 (step 264), and a multimedia channel is established between the device 109 and the VOD server 105 (step 266).

The foregoing process is illustrated graphically in FIG. 2b.

It will be appreciated that the foregoing example of FIGS. 2a and 2b is merely illustrative of the broader principles; other embodiments will be readily apparent to one of ordinary skill, such as when the VOD server 105 and client mobile device 109 reside within the same domain.

Further, the VOD server 105 of the exemplary embodiment could easily be replaced within the system by another client mobile device (e.g., PDA, cell phone, laptop, etc.) or other type of system with which it is desired to (i) establish a session and (ii) transfer media, data, etc.

Protocol translation may also occur between domains, as is well known in the art. For example, the CMD domain may utilize a SIP, WAP/WSP or comparable protocol in communication with an edge server (e.g., SIP or WAP gateway) or proxy, the proxy performing protocol translation to e.g., SSP for communication with the VOD server 105 or other indigenous MSO device. Hence, the invention contemplates both direct (un-translated) and indirect (translated) protocol communication between “endpoints”.

Another salient concern to providers of on-demand content (especially content which is proprietary or commercially valuable) is the security of their systems, so as to prevent others from viewing or intercepting content that should not be available to them. In the context of SIP-based solutions, SIP itself is predicated on an architecture that is very much generalized and from which several trust models may be defined. These security solutions may comprise, e.g., hop-by-hop, end-to-middle and end-to-end type security solutions. These mechanisms are intended to provide important security functions such as authentication (including identification and verification of the user and/or his or her equipment), confidentiality (including protection of the payload or other data from being read or extracted) and integrity of content (including verifying or assuring that the content has not be tampered with or altered), that is distributed over the network.

It is noted that SIP requests and responses generally cannot be fully encrypted or protected for integrity on an end-to-end basis since parts of the messages by definition must be made available to intermediary entities (e.g., proxies) for routing purposes, and to permit modification of the messages. At the application layer, it is possible to use HTTP (HyperText Transfer Protocol) authentication and S/MIME (Secure/Multipurpose Internet Mail Extensions), since SIP carries MIME components. S/MIME has the disadvantage that it is based on public key certificates, and may in some instances result in the generation of very large messages (which are ideally avoided over a wireless channel due to bandwidth considerations). At the lower layers (e.g., transport and network) of the protocol stack, either TLS (Transport Layer Security) or IPsec can be used to secure the entire SIP message. Both UDP and TCP may be used in IMS, with UDP being the default protocol).

In architectures that utilize an IMS, a 3GPP IMS subscriber will have both an IP multimedia private identity (IMPI) and at least one IP multimedia public identity (IMPU). To participate in receiving streamed on-demand content, an IMS subscriber must register at least one IMPU with the IMS, which is used for authentication purposes. 3GPP IMS security architecture is well known in the art (specified in TS 33.203), and as such will not be discussed further herein. Rather, a salient part of the significance of IMS is that the utilization of SIP, or other session protocols, allows for security to be implemented at a wide variety of protocol stack layers, and not necessarily be limited to a single layer (e.g., application layer, transport layer, etc.). Security in different layers of the protocol stack generally provides enhanced and complementary protection.

Referring now to FIG. 2c, the general process flow for the exemplary embodiment of the invention is described. As shown in FIG. 2c, on-demand content generally originates from a content origination point 230 where it is sent and loaded onto a server 234 (e.g., a VOD server 105). The content will be cataloged 236 so that the requester of the on-demand content, whether from a CPE 112, CMD 109 or other device has an understanding of the content that is being requested. Cataloging structures and techniques are well known in the arts, and accordingly not described further herein.

After a request is made for the on-demand content by a CMD 109 or CPE 112, the on-demand server will format the content for transmission over the network 238. The channel that has already been established between the VOD server 105 and a CMD 109 requesting on-demand content (per the method 200 of FIG. 2) begins to transmit the content over the network 240. The CMD 109 or CPE 112 can subsequently modify transmission parameters based on feedback from the subscriber 242.

In one embodiment, a simple streaming service, such as that defined in 3GPP TS 26.233 v.6.0, is utilized that includes a basic set of streaming control protocols, transport protocols, media codecs and scene description protocols useful in establishing streaming sessions between a content containing server (e.g., a VOD server 105) and a Client Mobile Device 109.

The CMD 109 comprises an active PDP (packet data protocol) context in accordance with the CSP 106 that enables IP packet transmission at the start of session establishment signaling. The setup of the on-demand content streaming service is accomplished in the illustrated embodiment by sending an RTSP SETUP message for the on-demand content chosen by the subscriber via the CMD 109. This returns the UDP (user datagram protocol) and/or TCP (transport control protocol) port/socket etc. to be used for the respective on-demand content. The CMD then sends a RTSP PLAY message to the server, which then starts to send one or more streams over the CTMS or other interface to the CSP network.

In one aspect of the present invention, the system architecture comprises a “progressive” downloading capability, which allows for starting media playback while the file or media data is still being “downloaded” to the CMD 109. The function works by using a HTTP download over TCP/IP connection, and this service option is available for specific media types that have a container format suitable for progressive download (e.g., audio, video, timed text). A progressive-download session is established with one or more HTTP GET requests issued by the CMD 109 to the VOD server 105. The media resource (e.g. a progressively downloadable file or other data structure) is pointed by a valid HTTP URL.

PSS (packet streaming service) includes a number of protocols and functionalities that can be utilized to allow the PSS session to adapt transmission and content rates to the available network resources to maintain an acceptable QoS (Quality of Service). The goal of this is to achieve highest possible quality of experience for the CMD user consistent with the available resources on the CSP network 106, while maintaining interrupt-free playback of the media. This requires available network resources to be estimated to at least some extent (consistent with the media), and that transmission rates are adapted to the available network link rates. This approach helps prevent overflowing network buffers and thereby avoid packet losses. Techniques to accomplish these goals are well understood in the art, and as such will not be discussed in any further detail herein.

In another exemplary embodiment of the present invention, the streaming session between the CMD 109 and the VOD server 105 includes “trick-mode” functionality. This functionality can be accomplished by using a streaming protocol such as RTSP which incorporates one or more states or modes such as, e.g., PLAY, RECORD, PAUSE and TEARDOWN. These modes allow a user to interactively alter the state of the streaming on-demand media, although other methods of accomplishing trick mode functionality to streaming media content can be utilized.

In the exemplary embodiment, the variable and fixed delays normally associated with an HFC VOD infrastructure are simply replaced with the fixed and variable delays of the 3G or other bearer networks (as well as any of those associated with utilized portions of the HFC or other networks).

This trick mode functionality is especially significant in a smartphone or PDA-over-cellular context, since RAN dropouts, etc. may be less amenable to uninterrupted real-time viewing that a traditional cable/CPE system. Hence, where the user's session “drops out” or otherwise terminates, they can simply re-establish the SIP session, rewind to the point where the content dropped out, and continue viewing. This is a potential problem with prior art “cellular TV”; i.e., since with its broadcast nature, the subscriber can't rewind, and some cellular dropouts are considered inevitable during operation.

Further, it will be recognized that on-demand content need not be limited to “one-way” access by a CMD 109, etc. Rather, the VOD/network servers may also act like a video mailbox of sorts, with the content originating from a CMD 232 or other device such that MSO subscribers are able to leave each other video clips/messages on the MSO servers (or their designated proxy) for later playback “on demand” at the message recipient's convenience. In an exemplary embodiment, a cellular telephone with the ability to capture streaming video via an indigenous camera such as the Sony Ericsson®S710 camera/video phone or Motorola® V710 could capture a media file, such as “baby's first steps”. The cellular telephone user can then establish a multimedia session with an OD server as previously discussed herein, and transfer the file for storage onto the OD server or other designated storage device (such as an associated HDD, RAID or the like). This content can then later be retrieved by the subscriber who placed it onto the OD server, and/or by any other MSO subscriber authorized to do so (such as via password- or public/private encryption key based authentication if desired). Also, retrieval of the stored multimedia file need not be made by the cellular telephone that sent the file, but rather can be retrieved by the MSO subscribers home CPE, etc. as is well understood in the cable networking arts. In this capacity, the subscriber could capture videos of interest using their mobile device, upload them to the OD server of the MSO, and then play them back (via a direct streaming, download, or VOD session to their CPE) at their home or enterprise when desired.

Additionally, in another variant, subscribers can enable others serviced by the same MSO to access their uploaded content, such as via a password, challenge phrase, encryption key, or other security/access mechanism of the type well known in the art. For example, the foregoing “baby's first steps” video could also be viewed by the grandparents of the subject infant. Such viewing can be almost instantaneous; once the content is uploaded to the MSO server, a carousel or other downstream notification/delivery mechanism can notify the secondary viewers (e.g., grandparents) of the availability of the content, such as via a message on their EPG. More proactive methods of notification can be used, such as where the MSO (or its proxy) issue an e-mail, page, SMS message, or other notification spontaneously upon receipt of the content. Such notification can also be issued by the CSP or WSP if desired, such as part of the client application running on the CMD, which issues an automatic or elective “push” to a CSP/WSP server which issues the requisite notification.

Similarly, upstream requests from secondary viewers (e.g., from the grandparent's CPE to their MSO server) can be utilized to instigate the download of a notification, updated directory/EPG, inventory or listing of available “personal” content, or even the content itself.

Myriad other approaches will be recognized by those of ordinary skill provided the present disclosure.

While the establishment of SIP or other sessions has been primarily discussed in the context of establishing a streaming on-demand content session between a mobile device and a VOD server, it is further contemplated that the CMD 109 could also be used to establish a session between a mobile device subscribers home network (e.g., an HFC network servicing the subscriber's home CPE) and a VOD, thereby allowing on-demand content to be streamed to a subscribers home rather then the mobile device that is invoking the SIP session. For example, in one exemplary embodiment, the client application running on the CMD 109 acts as a proxy for the CPE 112, effectively instructing the VOD server or other OD server to initiate a session between the server and the CPE 112 (as opposed to, or in addition to, the CMD 109). In one variant, the CMD 109 sets up a first session with the server, the latter which is instructed by the CMD 109 to initiate a second, parallel session with the CPE 112. The necessary information for setting up the second session (e.g., CPE ID/tuner ID, MAC address, etc.) can either be passed from the CMD 109 from its internal storage device, or alternatively passed upstream from the CPE 112 to the server, under issuance of specially formatted message issued by the server to the CPE 112 (under instigation by the CMD 109).

This functionality advantageously allows an MSO subscriber to access on-demand content remotely so that it can be sent to a home network device for storage and/or later viewing.

It will also be recognized that another mobile client (CMD) or device may be used as the basis for the SIP “server”. For example, a second CMD can act as the “server”, such that on-demand or streamed content can be originated from the server CMD, and routed over the bearer network (e.g., 3G IMS system) to the first CMD. Here, the two CMD act as endpoints (rather than the VOD server/CMD model previously described). The session can be controlled and routed through the MSO network (or an MSO proxy entity) such that the benefits described herein (e.g., aggregated billing, access provided to only MSO/CSP “linked” customers) are provided and controlled, as compared to a normal CMD-to-CMD SIP session using only the CSP.

### Mobile Device Architecture and Operation—

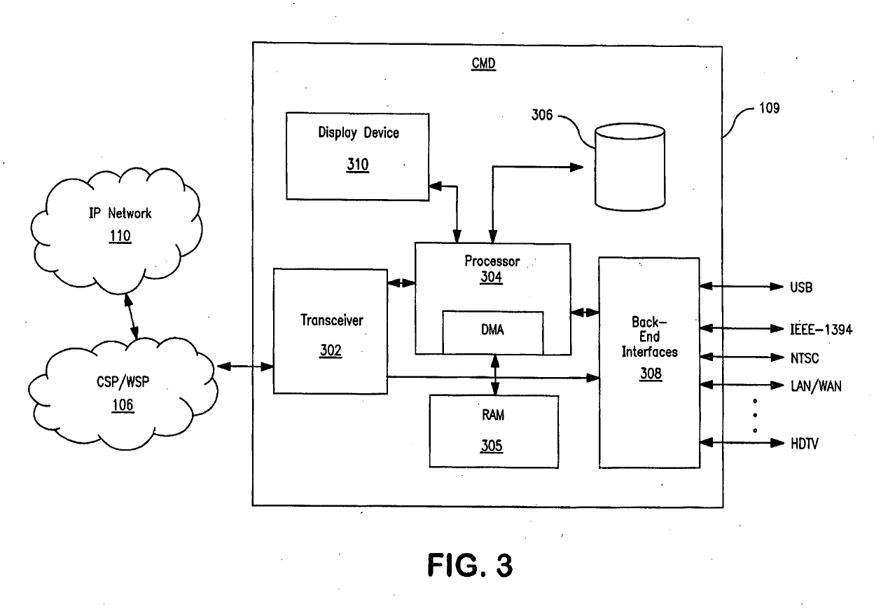

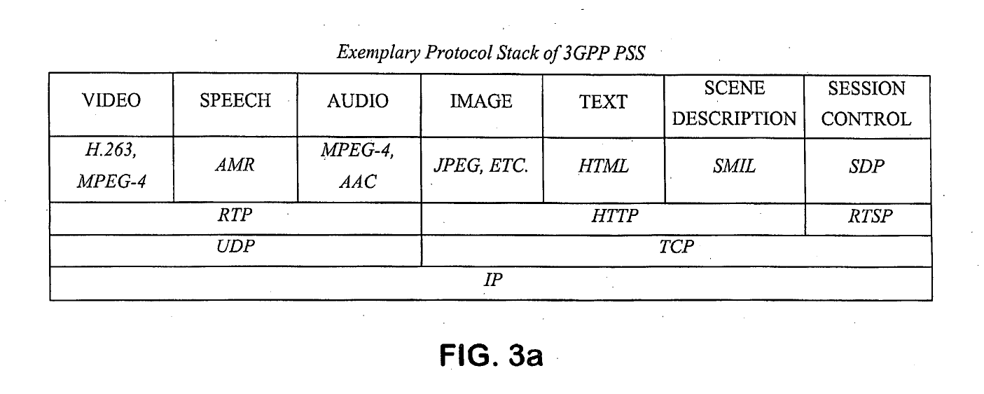

Referring now to FIG. 3, one exemplary embodiment of the mobile device 109 architecture of the present invention is described. In the illustrated embodiment, the CMD 109 comprises a transceiver 302 front-end that is coupled to a network, whether this is via a wireless RF connection (e.g., GSM, CDMA, TDMA, PCS, OFDM, etc.) to a cellular base station, over an 802.11 wireless network, a wired (e.g., RJ-45) connection, or any other suitable means to connect a device to a packet switched or circuit switched service network. Inside the mobile device 109 is a digital processor 304 with direct memory access (DMA); random access memory 305 (RAM) electrically coupled via the DMA of the processor 304; an optional mass storage device 306 (e.g., a RAM, hard drive, USB key, Flash memory stick, etc.); a display device 310 for viewing the on-demand content, and optional back-end interfaces 308 which may include, e.g., USB/mini-USB, IEEE-1394 (Firewire), NTSC, LAN/WAN, 802.11, Bluetooth, etc. The device may also optionally be equipped with “Smart USB” capability wherein applications and other software may be disposed on a removable media that can be on and accessed by the device 109.

In one exemplary embodiment of the client mobile device 109, the mobile device comprises a 3G or similar smartphone or PDA (such as the exemplary Motorola A845 UMTS videophone) that includes SIP or WAP (WSP) client software that enables sessions to be established between the CMD 109 and a remote entity such as the VOD server previously described. In another exemplary embodiment, the client mobile device 109 comprises a laptop or notebook computer such as the Dell Inspiron® notebook line used as the platform for a CMD 109 acting as a SIP or WAP client. In yet another exemplary embodiment, a device such as the exemplary Motorola Ojo® videophone is used as the basis for the SIP or WAP client in accordance with the principles of the present invention.

It will be recognized that where significant mass storage capability is available, the exemplary methods and apparatus described in co-pending and co-owned U.S. patent application Ser. No. 11/080,693 filed Mar. 14, 2005 entitled “METHOD AND APPARATUS. FOR NETWORK CONTENT DOWNLOAD AND RECORDING”, incorporated herein by reference in its entirety, may be used consistent with the present invention for download and recording or “burn” of content by the CMD or an associated device. In this fashion, the CMD user is given the capacity to not only view and interface (e.g., use “trick modes”) with the content, but also selectively purchase and record the content onto a fixed or other storage medium (e.g., HDD, DVD/CDROM, etc.). Consider, for example, the circumstance where a subscriber of a given MSO and CSP/VSP (which may be one on the same or have a cooperative agreement, as described subsequently herein) is on vacation away from their home, and they wish to watch a given new release movie. They may not have local cable television or satellite access, or may simply wish to purchase or obtain the content from their “home” MSO (e.g., Time Warner Cable). Utilizing the present invention, the subscriber can access their home MSO network on-demand features, and download the content. Using a connected or integrated burner or mass storage device (e.g., the HDD on a laptop), the subscriber can record the downloaded content onto the mass storage device, which can then be coupled to a playout device or monitor so that the subscriber's family or guests can view the movie on a full-sized viewing device (versus trying to view a laptop or cellular phone viewing screen). Since the content is now recorded on the mass storage device, all of the “trick mode” functions such as pause, FF, etc. are available via traditional functionality found on such devices (as opposed to stream-based “trick modes” as previously described).

This functionality can also be coupled with other aspects or requirements; e.g., (i) making the recording contingent upon purchase and/or inclusion of digital copyright or steganographic data; (ii) allowing for the content to be released contemporaneously with that in retail or rental channels when such purchase is made, etc.

As noted above, the present invention can also be used to “play out” directly to a viewing or similar device via, e.g., a back-end interface (USB, Firewire, 10/100/1000 over RJ-45, 802.11, etc.) on the receiving CMD 109. For example, a cellular phone with high speed USB interface can be used as the medium or gateway by which the connected monitor or viewing device receives the downloaded content. The client application resident on the CMD 109 can also be configured to interface with a corresponding client application or program on the connected monitor or viewing device, this allowing for control of the content stream remotely. For example, consider the case where the subscriber has connected their laptop computer (e.g., 17-inch Powerbook™ G4 manufactured by Apple Computer of Cupertino, Calif.) to the back-end interface of their 3G cellular telephone, the latter also communicating via its front-end (cellular) interface with their CSP. A VOD client is resident on the 3G phone, as well as a “master” client or distributed application (DA) on the laptop. The master client on the laptop can then be used to communicate streaming or trick mode commands to the COD server via its proxy, the “slave” client running on the 3G phone, such that full VOD-based trick mode capability is provided to the laptop or other such connected device.

FIG. 3a shows one exemplary embodiment of a mobile device 109 protocol stack in the context of a 3GPP PSS device. Some characteristics of the exemplary protocol stack include a session description protocol (SDP) 374 which is a format for describing streaming media initialization parameters. The SDP 374 has been published and defined by the IETF as RFC 2327. The real time streaming protocol (RTSP) 376 was developed by the IETF and published as RFC 2326 and is a protocol for use in streaming media systems which allows a client to remotely control a streaming media server, allowing for trick functionality such as “play” and “pause”. RTSP servers typically will use the real-time transport protocol (RTP) 354 for the actual audio/video data transport.

As for the audio and video codecs implemented in the exemplary 3GPP PSS protocol stack of FIG. 3a, the exemplary H.263 350 and MPEG-4 352 visual are typical adopted video codecs, while AMR 358, MPEG-4 352 and AAC 360 are adopted as speech/audio codecs, respectively. RTP 354 and UDP 356 are used as the transport protocols for the video/speech/audio portions, while HTTP 368 and TCP 370 are typically used for still image presentation.

It is noted that the methods described herein are effectively platform-agnostic and implemented at least in part from the client end; hence, any number of mobile devices configured to receive multimedia or streamed video content may readily be adapted to provide the functionality of the present invention, typically through only software modifications. Specifically, in one variant, the mobile device is configured to include a SIP client application (such as that manufactured by Winphoria®, a division of Motorola®) adapted to implement SIP sessions. The serving client (SIP “server”) provides the multimedia or video packet data in the form of a stored file, buffered data, etc. over the 3G bearer (cellular GSM/GPRS) network to the other client (“client”). Such client programs can be readily loaded onto existing platforms, thereby minimizing the degree of difficulty and retrofitting (hardware or otherwise) to existing mobile devices. Hence, the MSO, CSP/WSP, or both can distribute for example “VOD” software upgrades or packages, such as via an SMS, e-mail, WAP push or other mechanism to the mobile client 109, which can then be downloaded and installed directly on the CMD 109 to provide the OD capabilities described herein.

It will also be recognized that a laptop or notebook computer has clear distinctions from a cellular phone/smartphone from the perspective of “24-hour” user availability. Specifically, relatively few people carry a laptop with them at all times (even in their car) such that when they want an instructional video or the like (e.g., how to change a flat tire), they cannot (i) pull out the laptop, (ii) connect to a nearby WiFi hotspot (if there is one), and (iii) stream the desired content. Conversely, most everyone carry a cellular phone, and no need exists for a local WiFi hotspot, but rather just cellular coverage (which is very far reaching at the time of this writing). This underscores another salient advantage of the present invention (when embodiment in the cellular telephone variant) over prior art solutions such as Movielink, wherein the user must have a laptop or notebook computer (or other PC) to download and play the content.

### Network Server—

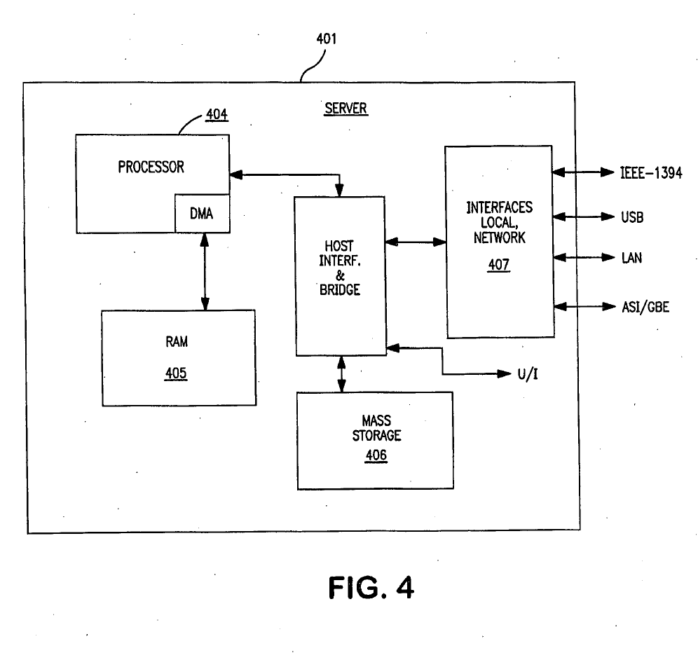

Referring now to FIG. 4, one embodiment of an improved network electronic device according to the present invention is described. As shown in FIG. 4, the device 401 generally comprises an OpenCable-compliant network server module adapted for interface with the HFC network 101 and gateway 107 (e.g., CMTS) of FIG. 1. The exemplary device comprises digital processor(s) 404, RAM 405, a mass storage device 406, and a plurality of interfaces 407 for use with other network apparatus such as IP routers and other packet network devices, network management and provisioning systems, local PCs, etc. Other components which may be utilized within the server device 401 include amplifiers, board level electronic components, as well as media processors and other specialized SoC or ASIC devices. Support for various processing layers and protocols (e.g., 802.3, DOCSIS MAC, OOB channels, DHCP, SNMP, H.323/RTP/RTCP, VoIP, SIP, RTSP, etc.) may also be provided as required. A VOD application is also disposed to run on the server module 401 to provide a functional interface for VOD session requests received from CPE 112 on the HFC Network, CMDs 109, or other entities in direct or indirect communication with the server. The CMD server 401 may also be a dedicated device if desired; i.e., configured to service only CMD/WSP/CSP originated session and content requests. These additional components and functionalities are well known to those of ordinary skill in the cable and embedded system fields, and accordingly not described further herein.

The server device 401 of FIG. 4 may take any number of physical forms, comprising for example one of a plurality of discrete modules or cards within a larger network head-end or edge device (e.g., hub site, CMTS) of the type well known in the art, including the MEM 162 itself. The server may also comprise firmware, either alone or in combination with other hardware/software components such as those previously described (e.g., disposed in the afore-mentioned edge device). Alternatively, the server module 401 may be a stand-alone device disposed at the head end or other location (such as a VOD server 105 or application server 104), and may even include its own RF front end (e.g., modulators, encryptors, etc.) or optical interface so as to interface directly with various portions of the HFC network 101. Numerous other configurations may be used. The server device 401 may also be integrated with other types of components (such as satellite transceivers, encoders/decoders, etc.) and form factors if desired.

As yet another example, portions of the functionality may be rendered as a dedicated or application specific IC (ASIC) having code running thereon. For instance, the ASIC may be optimized for low power consumption or other performance metrics (gate count, speed, etc.) as well as efficient servicing of session establishment/teardown requests received from the CPE 112 or CMD 109. Myriad different configurations for practicing the server entity 401 of the invention will be recognized by those of ordinary skill in the network arts when provided the present disclosure.

It will also be recognized that the present invention may be readily adapted to high-speed data download paradigms such as the exemplary approach of co-owned and co-pending U.S. patent application Ser. No. 11/013,665 entitled “METHOD AND APPARATUS FOR HIGH BANDWIDTH DATA TRANSMISSION IN CONTENT-BASED NETWORKS” filed Dec. 15, 2004 and incorporated herein by reference in its entirety. In one embodiment, this exemplary approach utilizes existing VOD infrastructure (including LSCP commands) to effectuate high-speed data download to CPE. Similarly, in the context of the present invention, a similar approach can be utilized by providing the mobile client (or even an intermediary entity) with high bandwidth capability and LSCP or similar protocol support to permit a VOD-like high-speed download of data files, software applications, etc.

Any number of well known data throttling mechanisms may also be optionally employed to match the downstream data rate provided by the VOD server or other content network entity to that of the CSP/WSP network, since the latter will typically have significantly lower maximum data rates due to, inter alia, the code spread/bandwidth of their air interface. For example, in one variant, a feedback mechanism can be used wherein the receiving mobile device 109 (or an intermediary process) monitors the available bandwidth in the limiting network (such as via monitoring of FIFO buffer levels over time), and sends a throttling control or information message back to the VOD server or other distribution entity to adjust the downstream rate or pause for a period of time. Myriad other throttling or flow control approaches to controlling one or both of the network(s) between the providing server and the receiving mobile device may be used, as will be recognized by those of ordinary skill when provided the present disclosure.

### Business Methods

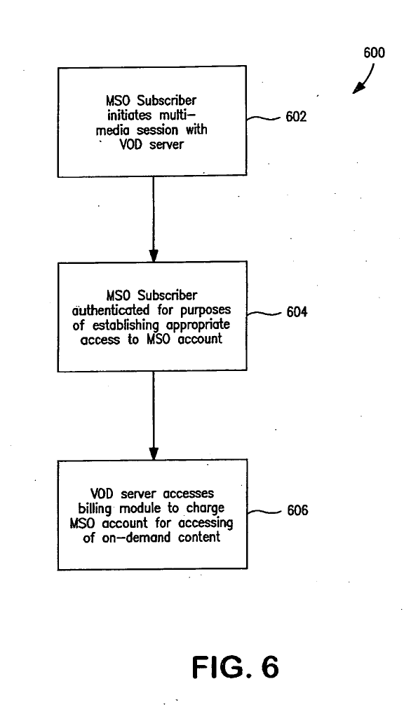

Business methodologies according to the present invention are now described in detail with respect to FIGS. 5 and 6. In a first exemplary embodiment, streamed content or data sent to a client wireless device (e.g., cellular telephone, PDA, laptop, etc.) can be billed directly to the subscriber's MSO account, such as via their monthly cable TV bill. The billing module 152 or other comparable process software at the MSO head-end is configured to obtain the relevant data regarding the subscriber's mobile device usage, which is then integrated with that subscriber's other activity to generate a monthly statement. Such data may comprise, for example, the number of movies or other content the subscriber has downloaded during the past billing cycle. As an alternative to the foregoing “per-use” model, the subscriber may be offered a plan wherein they can obtain an unlimited (or finite) number of downloads per billing cycle, such as for a flat fee. As yet another alternative, the selected/downloaded content or data can be billed on a “pay as you go” basis, such as via debit card, electronic payment service (e.g., “Paypal™”) or the like, with successful negotiation of the payment contract being a condition precedent to delivery of the content/data.

On-demand content as discussed previously also need not be full length features (e.g., movies); rather, music videos, promotional materials, tutorials, trailers, and other desirable content can be provided in a session/on-demand fashion (with or without trick mode functionality) without the extra effort associated with entering into a contract with a separate service provider. Similarly, it is anticipated that content developers (such as the MSO themselves, or a third-party entity such as a studio or channel) will develop content specifically adapted to the mobile delivery paradigm set forth herein.

For example, a mobile user at an airport awaiting his or her flight may utilize their cellular phone or “smart phone” to select and download an abbreviated (as compared to a full length feature) instructional standard definition (SD) golf video that was developed by the Golf Channel™ or the like particularly for such platforms. This can be optionally coupled to the VOD or other such server for delivery with trick mode functionality, wherein the subscriber can rewind and play back critical portions of the video dealing with golf swing technique. A unique intrinsic benefit to this approach is that, by using a mobile device such as a 3G smartphone, the subscriber can actually view the video content in situ, such as on the golf course or driving range. Either they (or a friend) can use the video to, inter alia, directly diagnose flaws in their swing. Prior art instructional video techniques would, at absolute best, require carrying a bulky laptop computer or the like to the golf course/driving range, which is highly impractical. To this end, the present invention also discloses an exemplary mobile device stand apparatus (FIG. 5) which can be used to place the mobile device in a position where the user can view it while simultaneously swinging their golf club. The device 550 of FIG. 5 can be made into literally any size and configuration, the lightweight tripod configuration of FIG. 5 being adapted to approximate the size, shape, and weight of a golf club (thereby consuming little space and adding little additional weight to the user's bag).

This process can also work in reverse; i.e., to provide content or data from the subscriber upstream. For example, in the context of the foregoing golf scenario, the mobile device (e.g., 3G smartphone with CCD or CMOS camera built in) can be used to capture image data in situ, and either store this data for later retrieval, and/or streaming back upstream to another entity. In one such use, the streamed video can be provided to a remote entity that can view the imagery and diagnose the user's flaws in real time (or near real time). For example, the MSO might run a “golf clinic” wherein professional golfer John Smith is made available during a specified time slot (e.g., Saturday morning, a popular time for golf) and provided a video feed for multiple of the MSO's subscribers. John Smith can then view the streamed video in real time, and provide diagnosis or feedback of the individual golfer's swing. Such feedback can be in any number of forms, ranging from a direct verbal (e.g., via VoIP or similar) and/or visual communication, to a text message or SMS message, an e-mail addressed to the user's designated e-mail account. Other feedback mechanisms (including a written analysis that is mailed to the subscriber's home with their monthly bill) may be used as well. He can also simply call the subscriber via their mobile number and converse with them directly for a few minutes, which would be of great interest to the golfers, especially if John Smith is famous. This provides the MSO's subscribers significant user satisfaction, and may be offered as a premium service that would ostensibly be available nowhere else.

As previously discussed, the captured video can also be uploaded to the MSO or third party server, for later download and viewing at the subscriber's premises (or those of other subscribers authorized to view the content). Such download may also be to a second appropriately equipped CMD 109, such as where two friends are on the golf course (at disparate locations) and one wants to show the other his technique, an interesting video anecdote (e.g., someone bending a club around a tree in frustration), etc.

Another exemplary “short” video according to the invention comprises a cooking video showing how to make a certain recipe of interest. For example, the user could select the video from a library of recipe video “shorts”, place their request and receive an on-demand play of the video short, with the ability to invoke trick mode functions such as “pause”, so that the viewer can follow along with the video in their kitchen. The aforementioned CMD stand (FIG. 5) can be adapted and scaled down to, e.g., fit on a kitchen countertop. These might even be offered as promotional items as part of a subscription or incentive program by the MSO and/or CSP/WSP. This type of application is especially useful in situations where the subscriber is not in their own kitchen, and hence does not have access to a computer, recipe book, etc.

The CMD-CMD approach can also be used here; e.g., where on person at one location wants to instruct the other at a second location how to bake a cake. The first user merely streams or uploads the content to the VOD server, wherein the second user can remotely access it via their 3G phone, PDA, etc.

Yet another exemplary “short” video might comprise an audio-visual language tutorial, wherein the user could learn a language or learn to play piano by watching and listening to the video.

Alternatively, short videos could be provided on emergency automobile repairs, which are specifically selected by the user based on their vehicle type/year (e.g., “How to change a flat tire on a 2004 Jaguar XJ8”).

Still another application comprises a mobile teleprompter, wherein the user can position the CMD such that they can view a video of slowly scrolling prepared text without having to continually press “page-down” or comparable keys. If a question or other interrupting event occurs, the user simply invokes the trick mode “pause” function until ready to resume.

Myriad other types and configurations of audio, visual, audio-visual, data, or other “content” downloads may be utilized consistent with the invention. For example, tutorials or instructional videos on literally any topic may be provided, as well as other forms such as gaming-related content. In a law enforcement or military context, video or imagery data (such as a recently obtained surveillance video) can be passed to mobile assets on-demand, thereby enabling enhanced data and intelligence fusion in the field. This is of particular interest in the context of Homeland Defense, where increased multi-source data fusion is highly desirable in order to more effectively analyze and correlate data. DHS, for example, might maintain a centralized server for uploaded video streams or clips from field agents, law enforcement, etc., that can then be remotely accessed by their data fusion entity

Referring now to FIG. 6, one embodiment of the aforementioned methodology is described in detail in the context of an exemplary MSO and associated cellular telephone user, although it will be appreciated that the methodology 600 is readily adapted to other contexts.

In step 602, an MSO subscriber wishing to access on-demand content initiates a multi-media session directly or indirectly with the network entity providing the content (e.g., VOD server 105).

Per step 604, the subscriber is authenticated for purposes of verifying that the subscriber attempting to access content through an MSO account is indeed the person named in the MSO account. This can be accomplished through a variety of means including via security architecture at the cable (MSO) side of the system architecture, and/or authentication via the CSP/WSP, IMS or any other portion on the IP network side of the system. “Layered” or end-to-end authentication may also be used, wherein two or more authentications (such as for example the user's 3G handset authenticating to its RAN, and the RAN or IMS server authenticating to the MSO network) are performed before access is granted.

Per step 606, the VOD server 105 can access the billing module 152 or other billing entity within the network, whether directly or indirectly, and write a record or data into the appropriate database so that the subscriber can be charged for the on-demand content on his/her home cable bill. Other relevant information such as date/time, content requested, CSP/WSP network identification, and so forth may be included in the billing information if desired in order to be included on the subscriber invoice.

Lastly, the billing module 152 or other entity responsible for generating billing data assembles the invoice or statement for the subscriber using the cable system component (e.g., monthly service/use charges) as well as those associated with content access and download via the CSP/WSP. These latter charges can be set off in a separate section of the statement if desired, or merely integrated into existing categories of services or charges.

Furthermore, where a business relationship exists between the CSP/WSP and the MSO, the subscribers cellular telephone or wireless access charges during the billing period (whether related to content access or not) may also be incorporated into the subscriber's MSO-generated bill. In this fashion, the subscriber can be provided only one “umbrella” invoice covering both their cable/satellite and wireless charges. Various of the foregoing data may also be optionally bundled with VoIP or similar access charges, such as for example where the MSO offers VoIP telephony service to their subscribers via their indigenous cable/satellite and IP infrastructure. This allows for an even higher level of service integration, with the subscriber receiving only one bill for their “home” (e.g., VoIP-based) and wireless telephony, as well as their cable or satellite and Internet access. In one exemplary configuration, the MSO can offer 1) cable access (including premium services such as DVR/PVR and on-demand), 2) high speed Internet access (such as the “Roadrunner®” offered by the Assignee hereof), 3) VoIP-based telephone service, 4) cellular (e.g., 3G GSM, CDMA, PCS, etc.) telephone and data service, and 5) WiFi or similar wireless LAN access via dedicated portals (described below).

It will also be appreciated that there are significant economies of scale to this approach for the service provider(s), such as by obviating the need for the printing and mailing or electronic processing of multiple separate monthly invoices, and reduced customer service overhead. Such integrated service packages also offer increased opportunities for promotions, incentives, and “cross-over” sales of products and services, thereby increasing the profitability of this paradigm.

As previously described, the present invention may be adapted to allow subscribers to access the desired content via means other than a CSP/WSP. For example, the MSO, itself may create or install a number of wireless “portals”, akin to or even coincident with so-called WiFi hotspots, wherein MSO subscribers can use their wireless devices to access the VOD server or other content-providing entity. Rather than using a cellular (e.g., CDMA, TDMA, GSM, etc.) air interface, the subscriber can access the portal via an 802.11, WiMAX, or even Bluetooth air interface, thereby bypassing the CSP/WSP infrastructure. These portals can be made so as to restrict access to MSO subscribers only, thereby providing maximum available bandwidth. Exemplary installations of such portals include airports or other transportation hubs, so-called cyber-cafes, universities, or even dedicated facilities solely for the purpose of providing such access. This approach provides an additional revenue source for the MSO, since many users may not utilize these services but for these particularly convenient (or secure) venues.

In addition, on-demand content need not be limited strictly to multimedia content. For example in a HFC/3G network, a 3G wireless user could potentially access any services available to MSO subscribers, such as interactive shopping or the like. The 3G users could also download smaller software applications (e.g., “micro” versions of applications specifically adapted for use on mobile platforms) required to enable any MSO services. For example, in order to know what VOD content is available, a micro-EPG (electronic program guide) application could be downloaded to the CMD 109 to permit the subscriber to browse via their handset. The present invention contemplates a wide variety of related services being extended to MSO subscribers in accordance with the principles hereof.

It is also noted that since much of the streamed content under the OD paradigm will comprise longer length features (e.g., several minutes potentially up to an hour or more), there is potentially a significant economic disincentive for subscribers to utilize their cellular telephones for such purposes, since their potential costs in terms of “minutes” used and possible roaming, etc. charges could be quite large. Hence, the exemplary embodiment of the business model of the invention contemplates that the CSP or other service provider, in conjunction with the MSO (which may be one in the same), will offer significant discounts or special rates for use of this service. As previously noted, the subscriber might pay a flat fee for a given number of uses per month, or pay only a “per use” charge with their cellular air time, etc. waived. These services could also be bundled as part of an incentive package, such as with the MSO VoIP telephony previously referenced, in order to give further incentive to subscribers. The service could even feasibly be offered free under this model, since the MSO/CSP could recover costs and make a profit off the VoIP service or other bundled or premium services (a “loss leader” strategy of sorts).

Delivery of the content to client or mobile devices (or the user's PC or laptop) can also be effected according to the methods and apparatus described in co-pending and co-owned U.S. patent application Ser. No. 11/198,620 entitled “METHOD AND APPARATUS FOR CONTEXT-SPECIFIC CONTENT DELIVERY” filed Aug. 4, 2005, incorporated herein by reference in its entirety, which describes, inter alia, the display and seamless transition of primary and secondary content within, e.g., a unified display mechanism (window). This integration allows for yet additional business or economic opportunities, since the content downloaded by the user can be coupled (seamlessly) to an advertising server or the like, the latter presenting the user with context-specific links or other information (secondary content) relating to the primary content (e.g., video) downloaded. The user then merely selects one or more of these links, and is provided additional information relating to the topic of interest (either the primary content or the links which individually may or may not be commercial in nature). These links can be accessed, e.g., a traditional IP or similar mechanism of the type previously described herein, such as the well known WAP protocol and browser. Hence, in the context of the foregoing exemplary tire change scenario, the display of the “how to video” could be followed by (or contemporaneously displayed or coupled with) a small number of targeted links, such as those relating to the vehicle manufacturer (e.g., www.jaguar.com), local service stations or towing services, police/emergency services, web sites for “never-go-flat” tire manufacturers, etc.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

1.-45. (canceled)

46. A method of providing on-demand at least one of a plurality of video segments to a third-generation (3G) capable mobile telephone from a content-based network, the network comprising at least an on-demand server, said method comprising:
establishing a session between said mobile telephone and said on-demand server over at least a Universal Mobile Telecommunications System (UMTS) subsystem;
receiving a request for an individual one of said plurality of video segments from said mobile telephone; and
transmitting said individual one of said plurality of video segments to said mobile telephone using at least one protocol supported by said UMTS subsystem.

47. The method of claim 46, wherein said subsystem comprises the IP
Multimedia subsystem (IMS), and the at least one protocol comprises the Internet (IP) protocol.

48. The method of claim 46, further comprising formatting said individual one of said plurality of video clips for transmission over said network to said mobile telephone.

49. The method of claim 46, wherein said request is generated from a menu-driven application capable of running on said mobile telephone, said menu driven application allowing for the selection of said individual one of said video segments.

50. The method of claim 46, wherein said at least one segment is specifically optimized for use on a mobile telephone.

51. The method of claim 46, wherein said method further comprises providing at least one trick-mode function selected from the group consisting of: (i) rewind; and (ii) fast-forward.

52. The method of claim 46, wherein said individual one of said plurality of video clips comprises user-created video content.

53. The method of claim 52, wherein said user-created video content is uploaded to said content-based network by a subscriber thereof, and said mobile telephone is also associated with a subscriber of said content-based network.

54. The method of claim 46, wherein said at least one protocol comprises a streaming service including: (i) at least one streaming control protocol, (ii) at least one transport protocol, and (iii) at least one scene description protocol.

55. The method of claim 46, wherein said at least one protocol is compliant with 3GPP Technical Standard 26.233.

56. The method of claim 46, wherein said at least one protocol comprises the Session Description Protocol (SDP), said SDP being configured to define session parameters and negotiate at least one codec to be used for said transmitting.

57. The method of claim 46, wherein said session is established via at least a push-to-initiate (PTx) function of said mobile telephone.

58. Apparatus for the transmission of at least one of a plurality of video segments on-demand to a 3G IP multimedia subsystem (IMS) enabled mobile device, comprising:
at least one cellular base station capable of communication with a client mobile device, said cellular base station capable of communication with a cellular service provider network; and
an on-demand server comprising at least said plurality of video segments and in communication with said cellular service provider network, said server further being configured to (i) establish a session with said mobile device via according to the Session Initiation Protocol (SIP) and Session Description Protocol (SDP); and (ii) receive a selection of one of said plurality of segments from a browser running on said mobile device;
wherein upon said selection received from said mobile device, an individual one of said plurality of video segments is transmitted from said at least one base station to said mobile device via said IMS subsystem and via said session and utilizing a codec negotiated as part of said session using said SDP.

59. The apparatus of claim 58, wherein said plurality of video segments comprise content having shortened length relative to the original version, or which is otherwise particularly adapted for display on a mobile device.

60. The apparatus of claim 58, wherein individual ones of said plurality of video clips comprise movie trailers.

61. The apparatus of claim 58, wherein individual ones of said plurality of video clips comprise video uploaded from another mobile device.

62. The apparatus of claim 58, wherein said apparatus further comprises apparatus configured to receive stream control protocol commands initiated from said mobile device, said commands being useful for controlling at least one aspect of the playback of the video segments.

63. The apparatus of claim 62, wherein the mobile device comprises a smartphone, and the apparatus is configured to receive content data initiated from the smartphone.

64. The apparatus of claim 58, wherein at least a portion of said plurality of segments is received from a cable television or satellite television network.

65. The apparatus of claim 58, wherein said apparatus further comprises apparatus capable of receiving a session request or establishment message generated via at least a push-to-initiate (PTx) function of said mobile device, and cause establishment of said session based at least partly on said message.

66. A method of providing content delivery services between two or more client devices, said method comprising:
establishing a session between a first client device and an on-demand server;
transmitting a video clip from said first client device for storage on said on-demand server;
establishing a session between a second client device and said on-demand server using at least the Session Initiation Protocol (SIP) and Session Description Protocol (SDP);
receiving a request for said video clip from said second client device as part of said session; and
transmitting said video clip to said second client device over an IP multimedia subsystem (IMS) of a Universal Mobile Telecommunications System (UMTS) cellular network.

67. The method of claim 66, further comprising particularly formatting said video clip for use on said second client device.

68. The method of claim 66, further comprising delivering said video clip to said second client device, said second client device and said on-demand server cooperating to provide trick-mode functionality for said video clip.

69. The method of claim 66, wherein at least one of said first and said second client devices comprises a 3G capable cellular telephone.

70. An on-demand apparatus for providing video content services to a mobile telephony device, said apparatus comprising:
a processor;
a memory in data communication with said processor, said memory having at least one computer program adapted to run on said processor, said at least one computer program configured to:
authenticating said mobile telephony device;
enable a session between said apparatus and said mobile telephony device over at least a Universal Mobile Telecommunications System (UMTS) cellular network using a session initiation protocol and an IP Multimedia Subsystem (IMS) thereof;
receive a request for pre-recorded on-demand video content from said mobile telephony device, said request being generated from a menu driven application adapted to run on said mobile device, said menu driven application allowing for the selection of said pre-recorded video content;
format said pre-recorded content for transmission over said network to said mobile device;
transmit said formatted pre-recorded content via at least said UMTS cellular network for delivery to said mobile telephony device;
receive a user-initiated trick mode command from said mobile device during playback of said pre-recorded video content thereon; and
invoke a trick mode function associated with said command, said invocation of said function causing the delivery of said video content to be changed in at least one respect.

71. The apparatus of claim 70, wherein said apparatus is disposed within a content-based network in data communication with said UMTS cellular network.

72. The apparatus of claim 70, wherein said change in said at least one respect comprises altering the data rate of a data stream used to deliver said content.

73. The apparatus of claim 70, wherein said change in said at least one respect comprises temporally altering the display of said content on said mobile device, said temporal alteration being selected from the group consisting of: (i) fast forwarding; and (ii) rewinding.

74. The apparatus of claim 70, wherein said user initiated trick mode command is generated based on user input to said menu driven application.

75. A cellular telephony device adapted to at least receive and play video clips on-demand, said device comprising:
a transceiver adapted to communicate with a Universal Mobile Telecommunications System (UMTS) cellular network base station;
a first computer program configured to establish a multimedia session with an on-demand server via the session initiation protocol (SIP) in order to receive at least one of said video clips therefrom;
a second computer program configured to generate a menu or presentation of the plurality of clips so that a user may select a clip;
a processor configured to process at least a portion of said received at least one video clip;
a display element configured to display at least said portion of said received at least one video clip;
a storage device configured to at least transiently store at least a portion of said received at least one video clip; and
a third computer program configured to play said received at least one video clip using a codec negotiated with said server as part of said establishment of said session, said third program being further configured to generate and cause transmission of a media stream control command to said server, said command invoking at least one trick mode function for said received video clip.

76. The cellular telephony device of claim 75, wherein said on-demand server comprises a video on-demand (VOD) server, said VOD server being adapted to transmit said video clips on-demand via at least a portion of a cable network.

77. The cellular telephony device of claim 75, further comprising:
a camera; and
a fourth computer program configured to capture images obtained by said camera and generate a video data stream based at least partly thereon;
wherein said fourth computer program is further configured to communicate with said first computer program to transmit at least portions of said video data stream to said server via a session.
